(19) United States
(12) Patent Application Publication
(10) Pub. No.: US 2013/0013397 A1
(43) Pub. Date: Jan. 10, 2013

(54) SYSTEM AND METHOD FOR BID-SENSITIVE, ZONE-BASED, MOBILE ADVERTISING

(75) Inventor: Seth D. LEVENSON, Calabasas, CA (US)

(73) Assignee: 3 LEGGED DOG, INC., CALABASAS, CA (US)

(21) Appl. No.: 13/179,550

(22) Filed: Jul. 10, 2011

(51) Int. Cl. G06Q 30/00

(52) U.S. Cl. 705/14.48; 705/14.71; 705/14.58

(57) ABSTRACT

A system comprising a first location within a bounding area, a second location within the bounding area, a first bid associated with the first location, and a second bid associated with the first location is disclosed. A method comprising receiving a first proximity ad zone associated with a first bid amount, receiving a second proximity ad zone associated with a second bid amount, intersecting the first proximity ad zone and the second proximity ad zone is also disclosed. Further, a method comprises assigning an accuracy assignment to a participant client device, assigning a first proximity ad zone around a first advertisement, associating a first bid amount with the first advertisement, assigning a second proximity ad zone around a second advertisement, associating a second bid amount with the second advertisement, and intersecting the first proximity ad zone with the second proximity ad zone.

### CROSS-REFERENCE TO RELATED APPLICATIONS

This application claims the benefit of U.S. patent application Ser. No. 12/540,315 filed on Aug. 12, 2009 and U.S. patent application Ser. No. 12/540,340, filed on Aug. 12, 2009, both of which are hereby incorporated by reference.

### BACKGROUND OF THE INVENTION

1. Field of Invention

This invention relates in general to interactive systems, and in particular to competitive advertising on mobile devices.

2. Description of the Related Art

Mobile device location systems are known in the related art, some of which include: U.S. Pat. Nos. 5,225,842, 5,280,457, 5,930,717, 6,084,547, 6,134,448, 6,813,499, 7,139,582, 7,212,157, 7,298,327, 7,403,853, 7,444,155, 7,486,233, 7,529,236, 7,561,104, 7,570,960, and 7,707,413, and U.S. patent application Ser. Nos. 12/193,669, 12/335,955, and 12/495,738. However, the related art consistently does not teach or suggest a digital artifact's accuracy zone in proximity with a mobile device accuracy zone, or accuracy zones between or among mobile devices in relation to one another.

Advertising on mobile devices is known in the related art. Some suppliers of advertising systems which allow an advertiser to target mobile devices include: Google AdWords, Yahoo!, Bing, and MSN.

An example can be found in U.S. Pat. No. 7,715,533 (Pradhan et al.), which discloses, in part, broadcasting advertisement information to mobile electronic devices with user-selected categories.

Interactive systems are also known in the related art, some of which include:

U.S. Pat. No. 5,933,100 (Loomis) teaches a GPS navigation system with a map, locations, and a navigation path.

U.S. Pat. No. 5,942,969 (Wicks) assigned to Sony teaches a treasure hunt game with clues sent to a pager.

U.S. Pat. No. 6,104,815 and RE39,644 (Alcorn et al.) teach mobile wager data communication with a casino using authentication and encryption.

U.S. Pat. No. 6,200,138 (Ando et al.) teaches a driving game with characters moving in a virtual 3D environment and an arrow indicator.

U.S. Pat. No. 6,884,171 (Eck) assigned to Nintendo, Inc., teaches distribution of image files on general purpose computing devices of varying display capabilities in certain moving vehicles and appliances.

U.S. Pat. No. 6,932,698 (Sprogis) teaches mobile device locations in a treasure hunt game.

U.S. Pat. No. 7,435,179 (Ford) teaches a shooting game where mobile devices communicate directly to each other designated to be in-range or out-of-range, but does not teach non-predetermined locations.

U.S. Pat. No. 7,441,203 (Othmer et al.) teaches a ticker on a mobile GPS device.

U.S. Pat. No. 7,460,863 (Steelberg et al.) assigned to Google, Inc. teaches radio frequency (RF) subcarrier band broadcasting and RF triangulation telemetry tracking (RF-3T) to a remote user gaming device with a GPS-tracked location with PIN-based player authentication.

U.S. patent application Ser. No. 09/801,491 (Arner et al.) teaches a two-way mobile wireless network with GPS data.

U.S. patent application Ser. No. 09/901,709 (Suzuki) teaches a spy game with a plurality of GPS gaming devices in a predetermined game program based on a first positional information and second positional information.

U.S. patent application Ser. No. 10/190,056 (Mages) teaches a plurality of transmitters to locate wired or wireless devices for casino games connected to a CDMA server and coupled to a GPS base station.

U.S. patent application Ser. No. 10/409,546 (Ellenby et al.) teaches treasure hunts, tours, and location-sensitive “GeoPets” that breed, have properties such as intelligence and beauty, and fight enemies.

U.S. patent application Ser. No. 10/455,646 (Barros et al.) teaches predetermined GPS locations of mobile devices in a game.

U.S. patent application Ser. No. 10/788,903 (Gentles et al.) teaches a distributed, loosely coupled network for wager-based gaming using web services.

U.S. patent application Ser. No. 11/163,329 (Robertson) teaches location-aware games, including scavenger hunts, played on a mobile device. However, Robertson does not teach non-predetermined locations set by users during game play.

U.S. patent application Ser. No. 11/317,875 (Loo et al.) teaches a virtual multi-dimensional 3D game with an advertisement displayed relative to a player's position based on factors such as: distance, orientation, environmental lighting, brightness, and visibility at a given time.

U.S. patent application Ser. No. 11/303,973 (Willis et al.) teaches selecting advertising content data based on location data in a video game.

U.S. patent application Ser. No. 11/414,967 (Milic-Frayling et al.) assigned to Microsoft, teaches photo images relating to locations along a journey, but lacks manipulation of the images or ability to relocate such images.

U.S. patent application Ser. No. 11/842,019 (Mullen) teaches a multiplayer, virtual playfield with GPS-based location devices where characters are controlled and object can be picked up and put down by a virtual game character by pressing an action button until the game or game level ends.

U.S. patent application Ser. No. 12/146,907 (Huston) teaches GPS-based location and messaging with zoom, pan, and tilt.

U.S. patent application Ser. No. 12/331,320 (Saunders et al.) teaches devices with GPS locations in a casino network.

WO2004061485 (Morse) teaches GPS locations for a golf course, a golf player, and a golf ball with predetermined golf course information with a mobile unit interfacing with a GPS.

Color teaches an iPhone or Android mobile application which allows users to share a recent public photo with others based on location and time.

Snapshot teaches a treasure hunting game on the iPhone.

Spore teaches a non-human creature creation game, but does not teach leaving genetic material in a geopositional location.

Software development kits (SDKs) are known in the related art, some of which include: Apple's iPhone SDK, Google Android, Microsoft Windows CE, Microsoft Windows Mobile, Palm OS.

However, the related art does not teach or fairly suggest a digital artifact in a non-predetermined or user-determined location capable of being obtained, altered, or released in another location for interaction by others. Furthermore, such systems in the related art do not teach or fairly suggest non-predetermined paths or aggregation of multiple digital artifacts in the non-predetermined or user-determined location. Moreover, the related art does not teach or fairly suggest locating a digital artifact in proximity with a mobile device, or proximity via accuracy zones around the digital artifact and the mobile device.

It can be seen, then, that there is a need in the art for an advertising priority bidding system which allows user-defined advertisements that are not predetermined. It can also be seen that there is a need to facilitate multi-user competitive advertising when the proximity of mobile devices to ad zones is unknown as to location and time. Moreover, it can be seen that there is a need for a self-service interface to designate competing advertising zones. Finally, it can be seen that there is a need to address any combination of these problems.

### SUMMARY OF THE INVENTION

To minimize the limitations in the prior art, and to minimize other limitations that will become apparent upon reading and understanding the present specification, this specification discloses a system comprising a first location within a bounding area, a second location within the bounding area, a first bid associated with the first location, and a second bid associated with the first location is disclosed. A method comprises receiving a first proximity ad zone associated with a first bid amount, receiving a second proximity ad zone associated with a second bid amount, intersecting the first proximity ad zone and the second proximity ad zone. A method comprises assigning an accuracy assignment to a participant client device, assigning a first proximity ad zone around a first advertisement, associating a first bid amount with the first advertisement, assigning a second proximity ad zone around a second advertisement, associating a second bid amount with the second advertisement and intersecting the first proximity ad zone with the second proximity ad zone.

The description of the preferred embodiments is to be understood as non-limiting examples of the present invention. The true scope of the invention is to be understood by the claims and not limited by the preferred embodiments. In a possible embodiment, a user can login to a web-based advertising administration system, set a pin on a location map with a bid, set a bounding area, and compete for advertisements served to localized users via their mobile devices when those users are close enough to the advertising zone.

An aspect of the invention is to provide a three-dimensional zone which can be used to allow bidders to compete for ad serving on a mobile device. An aspect of the invention is to facilitate bidding where the target consumer is not located within, but proximate to, an advertising zone.

An aspect of the invention is to provide a way to serve highest-bidder advertisements when a user is near, but not within, a targeted mobile device advertising region; the area around the user can overlap with the target advertising area, and does not have to overlap with the user's actual location.

An aspect of the invention is to allow users to place, locate, obtain, release, or alter a digital artifact by using a mobile device. In most preferred embodiments, the information can be recorded on a server. Further, the digital artifact can be relocated and obtained subsequently by other users.

An aspect of the invention is to provide a physical location which can be used to place, locate, obtain, release, or alter the digital artifact. Physical locations can be anywhere that a GPS or other location system can track; preferably a retail store or other physical location.

An aspect of the invention is to provide proximity location capabilities between a digital artifact having an accuracy assignment and a participant client device, such as a computing device having its own accuracy assignment.

### BRIEF DESCRIPTION OF THE DRAWINGS

Referring to the drawings in which like reference numbers represent corresponding parts throughout:

FIG. 1 illustrates a schematic diagram of a preferred embodiment of the present invention;

FIG. 2 illustrates a possible embodiment of the present invention involving a trading card game;

FIG. 3 illustrates a possible embodiment of the present invention involving an evolution game;

FIG. 4 illustrates a possible embodiment of the present invention involving a scavenger hunt;

FIG. 4B illustrates a possible embodiment of the present invention;

FIG. 5 illustrates a method diagram of a preferred embodiment the present invention;

FIG. 6 illustrates a possible embodiment of the present invention;

FIG. 7 illustrates a possible embodiment of the present invention;

FIG. 8 illustrates a possible embodiment of the present invention;

FIG. 9 illustrates a possible embodiment of the present invention;

FIG. 10 illustrates an interaction scheme of a possible embodiment of the present invention;

FIG. 11 illustrates a proximity aspect of a possible embodiment of the present invention;

FIG. 12 illustrates a proximity aspect of a possible embodiment of the present invention;

FIG. 13 illustrates a proximity aspect of a possible embodiment of the present invention;

FIG. 14 illustrates a proximity aspect of a possible embodiment of the present invention;

FIG. 15 illustrates a proximity aspect of a possible embodiment of the present invention;

FIG. 15B illustrates a proximity aspect of a possible embodiment of the present invention;

FIG. 15C illustrates a proximity aspect of a possible embodiment of the present invention;

FIG. 16 illustrates a proximity aspect of a possible embodiment of the present invention;

FIG. 17 illustrates a proximity aspect of a possible embodiment of the present invention;

FIG. 18 illustrates a possible embodiment of the present invention;

FIG. 19 illustrates a possible embodiment of the present invention;

FIG. 20 illustrates a possible embodiment of the present invention;

FIG. 21 illustrates a method diagram of another preferred embodiment the present invention;

FIG. 22 illustrates a possible embodiment of the present invention with participant client device outside an advertising zone;

FIG. 22B illustrates a possible embodiment of the present invention with participant client device inside an advertising zone;

FIG. 23 illustrates a schematic diagram of an embodiment of the present invention;

FIG. 24 illustrates a schematic diagram of an embodiment of the present invention;

FIG. 25 illustrates a possible self-service user interface of the present invention; and

FIG. 26 illustrates a possible self-service user interface of the present invention with geographic indicia.

### DETAILED DESCRIPTION OF THE PREFERRED EMBODIMENTS

In the following description of the preferred embodiments, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

References throughout the specification to “a possible embodiment,” “a preferred embodiment,” “some embodiments,” “an embodiment,” and like reference to “embodiment” are non-limiting examples to aid in understanding an element, function, way, result, means, structure, aspect, and/or benefit of the present invention. An “embodiment” provides that there is one or more embodiments that can involve the given element or aspect of the invention. Thus, multiple instances of “an embodiment” and like reference do not necessarily refer to the same embodiment.

It will be understood that “location” can refer to any physical or virtual location, whether or not the location is specified by a latitude and longitude point, altitude, tilt, direction, region, user-defined designation, proximity to a coordinate or landmark, or otherwise. It will be understood that “scavenger hunt” can also include a treasure hunt, search for an object or person, or contest. It will be understood that “area” can mean a region, proximate location, bounded area, two-dimensional or three-dimensional space, or series of coordinates defining a space. It will be understood that “physical location” refers to real-world locations and not to virtual locations. It will be understood that “associate” can refer to any relationship between two or more things, whether implemented by relational or non-relational database, object database, any markup language, database management system, spider, search engine, file system, query-capable system, or otherwise, or any combination or equivalent thereof. In an embodiment, associating can be initiated by clicking, pressing a button, tapping a touch-sensitive screen, or otherwise. It will be understood that “set” can mean “associate.” It will be understood that “drop” refers to releasing 506 of digital artifact 100. It will be understood that “numeric value” can mean any number or part thereof, whether involving currency, cost, price, winnings, points, or otherwise. It will be understood that all elements and combinations of elements described herein also include any equivalents thereof, now known or future-developed, and thus such description should not be considered limiting as any embodiments of the present invention. It will be understood that “zone” and “area” can refer to a two- or three-dimensional space (x, y, z), without limitation to a two-dimensional (x, y) plane. It will be understood that all measurements described herein can be metric or non-metric units.

### SPECIFICS OF THE INVENTION

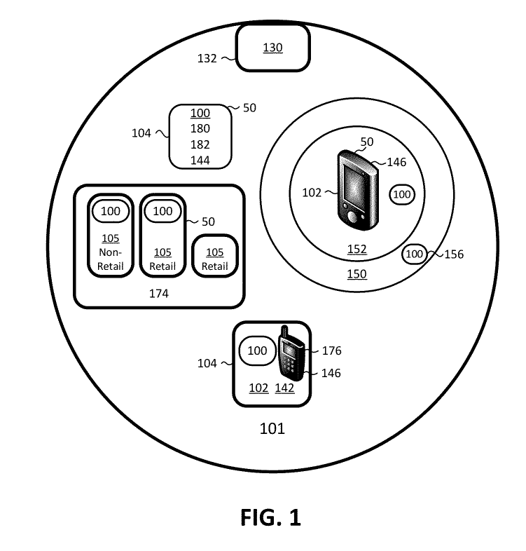

FIG. 1 illustrates a schematic diagram of a preferred embodiment of the present invention. Object 50 is shown in FIG. 1 with digital artifact 100, game 101, participant client device 102, non-predetermined location 104, predetermined location 105, out of bounds area 130, boundary 132, client application 142, computing device 146, proximity detector 150, proximity reach 152, proximity location 156, set of locations 174, mobile device 176, identifier 180, and asset 182.

Object 50 can be in game 101. Object 50 can be digital artifact 100. Object 50 can be participant client device 102. In an embodiment, object 50 can be digital artifact 100 and a second object 50 can be digital artifact 100. In an embodiment, object 50 can be digital artifact 100 and a second object 50 can be participant client device 102. In most preferred embodiments, objects 50 can be many digital artifacts 100. Object 50 can have a one-to-one or one-to-many correspondence with digital artifacts 100 and participant client devices 102. Object 50 can be an instantiated in memory on server 140. Object 50 can be any item in game 101. In most preferred embodiments, object 50 can have a location.

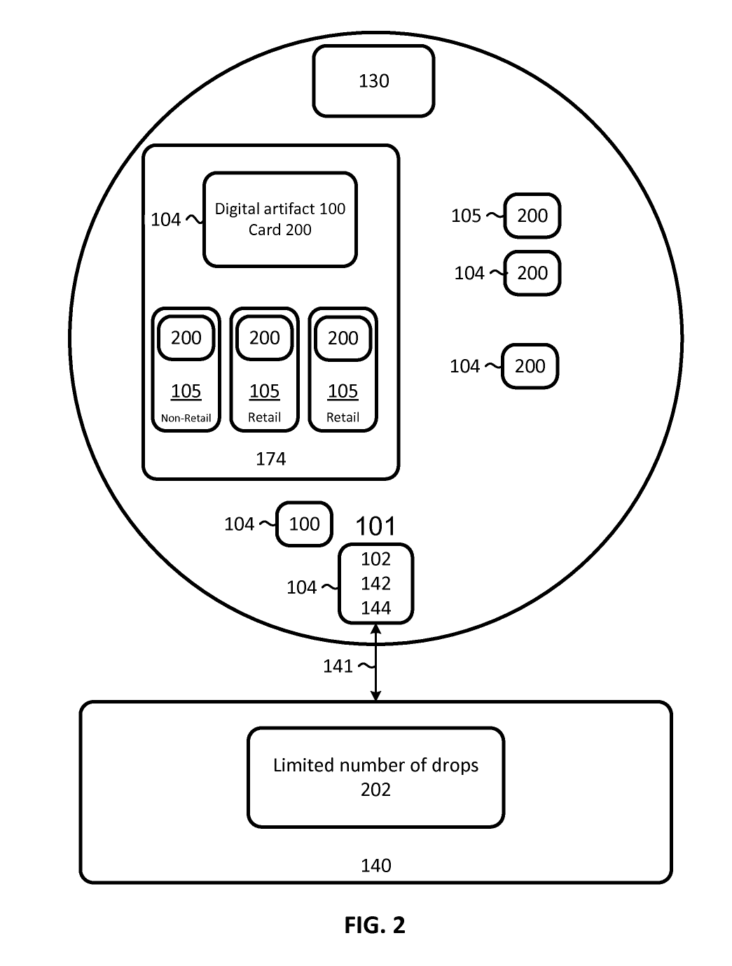

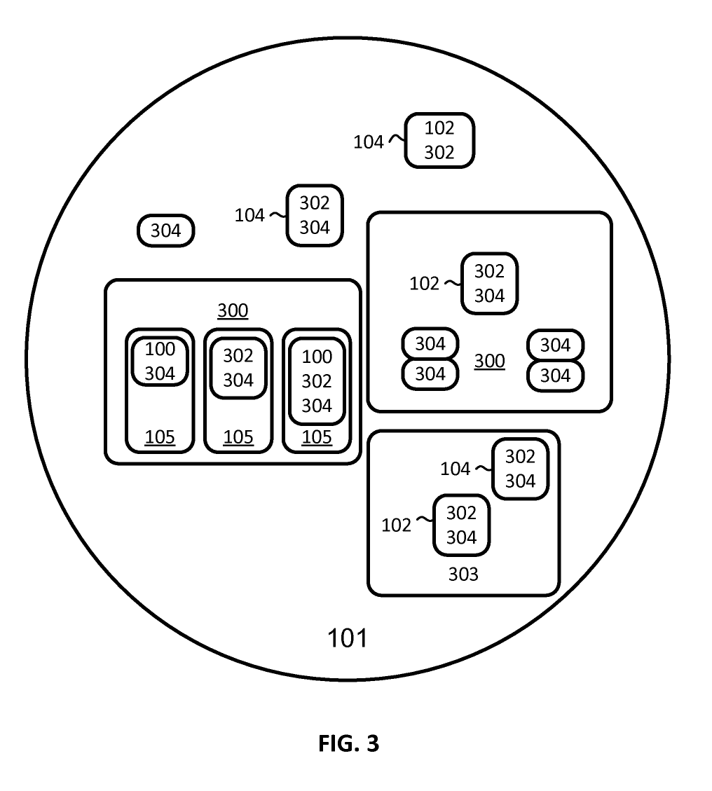

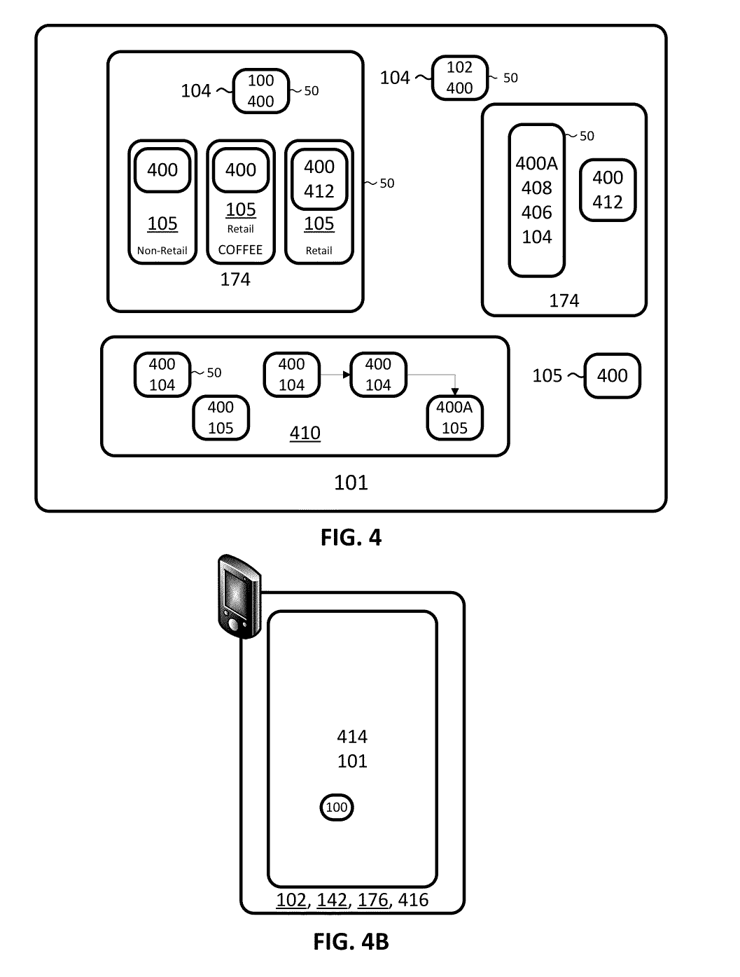

Digital artifact 100 can be associated with an at least one non-predetermined location 104. In most preferred embodiments, digital artifact 100 can have a GPS location with longitude and latitude. Digital artifact can be placed 508 at non-predetermined location 104 by a first participant client device 102 and obtained by a second participant client device 102. Digital artifact 100 can have identifier 180 and asset 182 associated therewith. Digital artifact 100 can be an object having a location. Digital artifact 100 can have, without limitation, any of the following data 144: message, text, comment, video, audio, image, binary data, xml, blob, clob, application data, pdf, word document, excel document, file, social networking connection, URL, or any combination or equivalent thereof. In a possible embodiment, digital artifact 100 can be released anywhere in game 101. In many preferred embodiments, locations where digital artifact 100 can be released is limited. In a possible embodiment, specific locations can be dynamically set by participant client device 102. In a typical scavenger hunt, there is a predetermined path which goes from point A to point B to point C. In a possible embodiment, a subset of possible points that are not predetermined can be used. Those points can correspond to set of physical locations. Locations can be set by latitude and longitude. Digital artifact 100 can be in an evolution game, such as genetic material 304. Digital artifact 100 can be any type of object represented in the real world. In some preferred embodiments, digital artifact 100 can be a trading card. Digital artifact 100 can be capable of being accessed on computing device 146; in most preferred embodiments, computing device 146 can have a GPS receiver or other means for deriving a location such as triangulation or IP address. In a preferred embodiment, based on direction 170 and non-predetermined location 104 of participant client device 102, client application 142 via locator 414 can indicate where participant client device 102 needs to go to locate digital artifact 100. In a possible embodiment, digital artifact 100 can be activated or deactivated. Activation can set the digital artifact as within game 101 or in round 500. Deactivation can set the digital artifact as being inappropriate or in some other way not acceptable by the system administrator. One of ordinary skill in the pertinent art would understand how to incorporate digital artifact 100 into the present invention based on the teachings of this specification. In various embodiments, digital artifact 100 can be participant client device 102, card 200 (FIG. 2), creature 302 (FIG. 3), genetic material 304, token 400 (FIG. 4), or primary token 400A. In some preferred embodiments, digital artifact 100 can be viewed from non-predetermined location 104 of participant client device 102 having tilt 172.

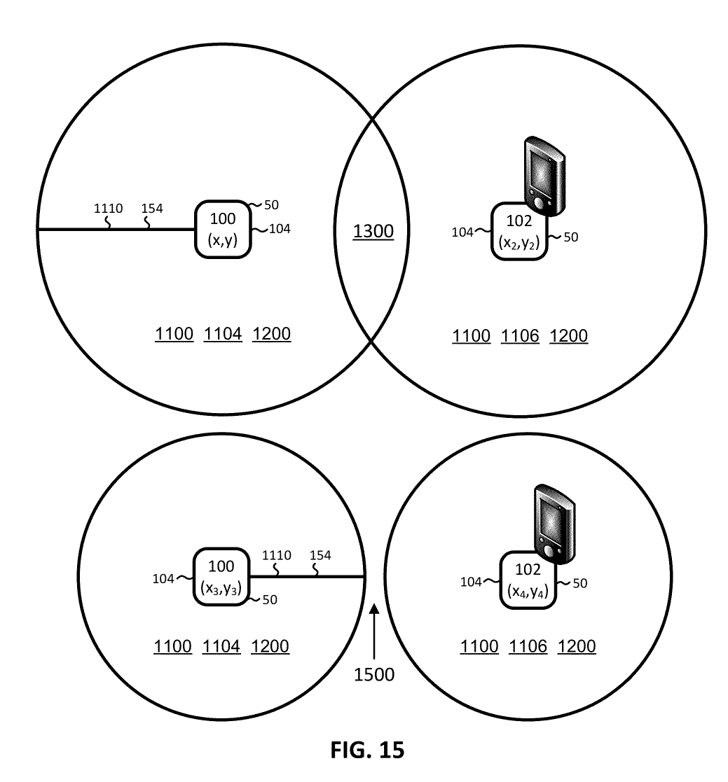

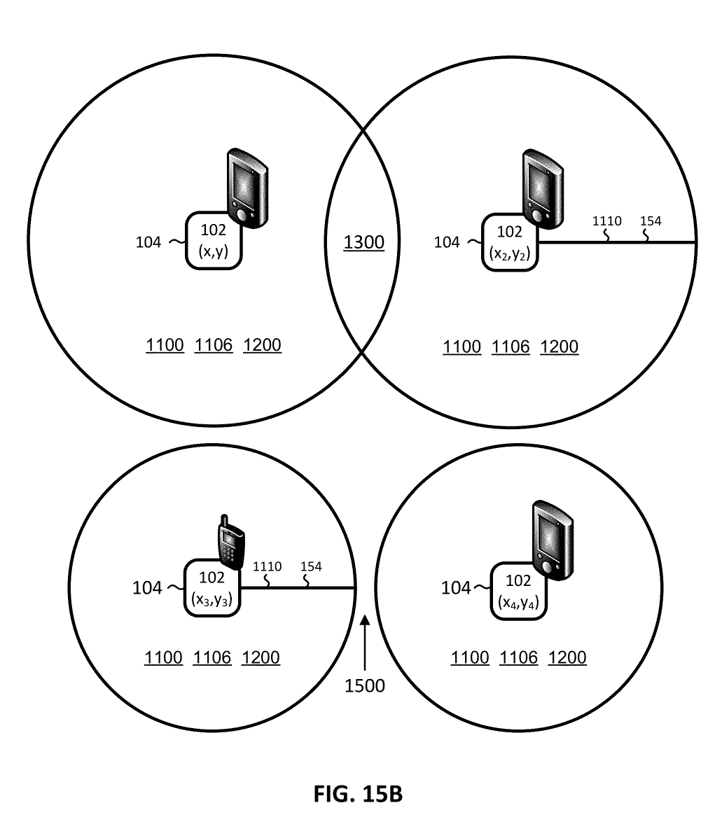

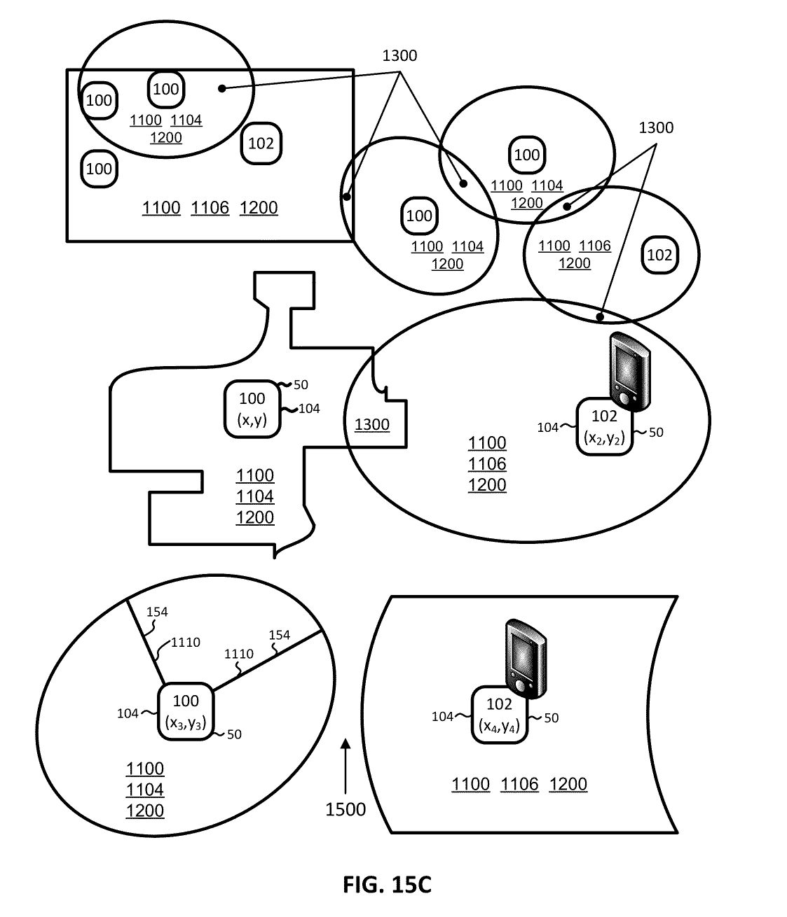

Game 101 can run on server 140. Game 101 can have objects therein, such as digital artifact 100, participant client device 102, or any element described in this specification. In most preferred embodiments, game 101 can run on server 140 and client application 142, and be accessed via participant client device 102. There can be multiple participant client devices 102. There can be “n” number of participant client devices 102 at a given time (for example, FIGS. 15B and 15C).

Participant client device 102 can be an object in game 101. Participant client device 102 can facilitate user interaction in game 101. Participant client device 102 can operate on computing device 146 or mobile device 176. In most preferred embodiments, participant client device 102 can obtain 504, release 506, locate 510, and/or alter 512 digital artifact 100. In some embodiments with creature 302, participant client device 102 can also absorb, spawn, mate, aggregate genetic material 304, genetically design, or otherwise interact with digital artifact 100. In an embodiment, participant client device 102 can be first participant client device 102 and picked up by second participant client 102. In a possible embodiment, participant client device 102 can be restricted from interacting with digital artifact 100. In a possible embodiment, participant client device 102 can associate one or more other participant client devices 102 in a user profile. In most preferred embodiments, participant client device 102 can have proximity reach 152 where digital artifact 100 can be within proximity reach 152.

Non-predetermined location 104 can be any location in the world. Non-predetermined location 104 can have a latitude and longitude. Non-predetermined location 104 can be associated with digital artifact 100. Non-predetermined location 104 can be user-defined location 1114 (FIG. 12). In an embodiment, participant client device 102 can define the non-predetermined location 104 by GPS location. A benefit of non-predetermined location 104 is in providing flexible game play. For example, in an embodiment, game 101 can thus commence, develop, and/or end with any non-predetermined location 104. Further, in an embodiment, digital artifact 100 can be obtained and released in any non-predetermined location 104. Thus, a further benefit of non-predetermined location 104 is to provide a degree of unpredictability which can generate higher interest levels and more repeat participation.

Predetermined location 105 can have characteristics of non-predetermined location 104 but instead, in an embodiment, predetermined location 105 can be pre-populated in server 140. Predetermined location 105 can be a specific set of locations within set of locations 174. Having predetermined locations 105 does not preclude having non-predetermined locations 104, and vice-versa.

Out of bounds area 130 can be defined by points. Although participant client device 102 can go into out of bounds area 130, participant client device 102 can be restricted from releasing digital artifact 100 in out of bounds area 130. A benefit of out of bounds area 130 is to reduce frustration with game 101. In most preferred embodiments, out of bounds area 130 limits the range of non-predetermined locations 104. In an embodiment, out of bounds area 130 and set of locations 174 can both limit the range of non-predetermined locations. Thus, a benefit can be to enhance user experience.

Boundary 132 can be coordinates that define a space. In a possible embodiment, points can correspond with a commercial location. In a possible embodiment, digital artifact 100 can only be released at an “n” number of non-predetermined locations 104, and participant client device 102 can be limited to only drop at non-predetermined locations 104 in set of locations 174, or within a preset radius 154 of any one of those locations.

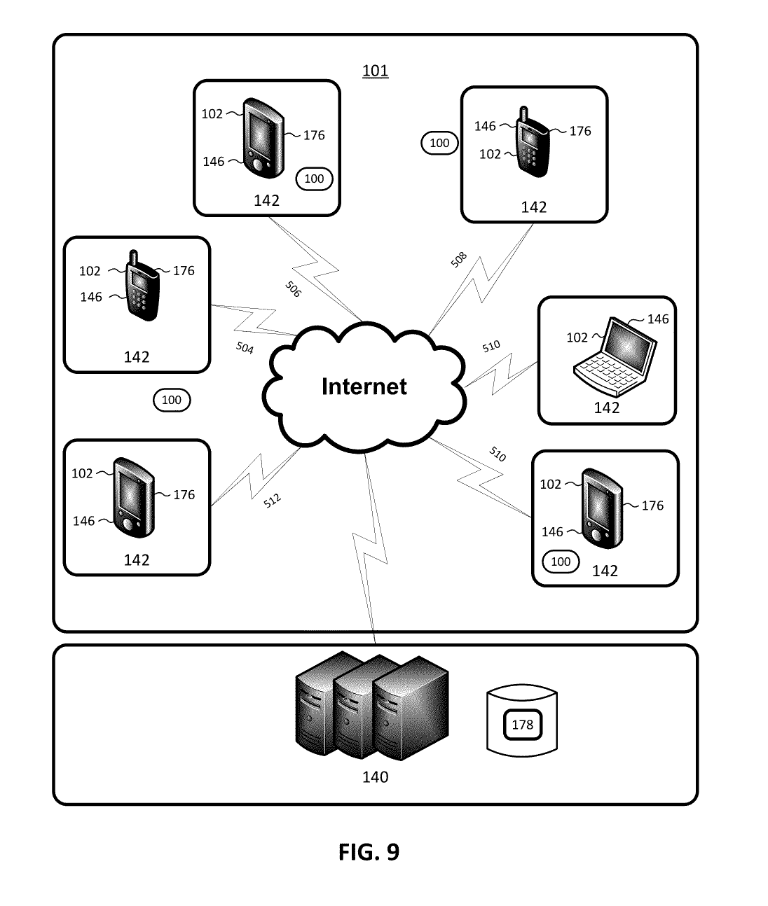

Server 140 can be accessible via the Internet or using any data communications protocol. A non-limiting illustration is shown in FIG. 9. Server 140 can calculate point information, GPS information, radius, radar, current locations of participant client devices 102, and any aspects of game 101 other than non-predetermined locations 104 or user-defined locations 1114. User-defined location 1114 can be set by an administrator on server 140 in most preferred embodiments, rather than by a non-administrator. Server 140 can be used to store the non-predetermined locations 104 or user-defined locations, any association or interactions thereof. Server 140 can provide information at an accessible website, display the information on mobile device 176, or relay to participant client devices 102 using push or pull technology.

Request 141 can occur between server 140 and client 142. Request 141 can have data 144. Request 141 can be made, by way of non-limiting illustration, via TCP, IP, IPv6, http, https, ftp, socks, over any port, point-to-point tunneling, virtual private network, peer-to-peer, or any proprietary protocol. Server 140 can be a computer running an operating system, whether a cluster, cloud, server farm, node in a network, or distributed network. Server 140 can initiate or receive web service calls from client application 142.

Client application 142 can have a user interface to create digital artifact 100. Client application 142 can be any computing device 146. Some non-limiting illustrations are shown in FIGS. 1, 9, and 10. In an embodiment, it is unnecessary to use client application 142 to allow data 144 and information from other sources to be used. This can provide flexibility by allowing other forms of data and information from sources external to game 101, thus enriching user experience. In a possible embodiment, creature 302 can be created in client application 142. Further, when genetic material 304 is released, action information can then be sent to server 140 via a web service call. Client application 142 can provide tools, data 144, or information in data 144 to help locate something. Some non-limiting examples can be clues, arrows, textual clues, highlighted path, map, text-based clues or riddles, images, video, audio or any other objects that correspond to the real world. In most preferred embodiments, client application 142 determines physical location. In a preferred embodiment, client application 142 can be on mobile device 176 having a GPS receiver. Client application 142 can communicate with server 140. Client application 142 can makes web service calls to server 140. Client application 142 can thereby update current location with the server 140. In most preferred embodiments, computing device 146 can be mobile device 176. In some embodiments where GPS receiver is not present, client application 142 can get location information from mobile device 176 by cell phone tower triangulation, or other non-GPS location information.

Computing device 146 can be any device with an operating system. Computing device 146 can be mobile device 176. In most preferred embodiments, computing device 146 benefits users by allowing them to participate in game 101. In an embodiment, computing device 146 can be used by a remote administrator, power user, or super user that can monitor whatever a user is doing via participant client device 102.

Proximity detector 150 can have proximity reach 152. In a preferred embodiment, proximity detector 150 can be a radar that displays objects and can track objects in relative proximity to a given proximity location 156 or non-predetermined location 104. In a preferred embodiment, proximity detector 150 can alert participant client device 102 in conjunction with locator 414 (FIG. 4B). In a preferred embodiment, proximity detector 150 can locate objects and display objects on computing device 146. Proximity detector 150 can be a user interface tool in many preferred embodiments. In an embodiment, proximity detector can coincide with accuracy assignment 1100 of participant client device 102.

Proximity reach 152 can be determined by radius 154. In an embodiment, proximity reach 152 can be roughly around digital imprint 100, participant client device 102, non-predetermined location 104, predetermined location 105, proximity location 156, card 200, area 300, creature 302, genetic material 304, token 400. In a preferred embodiment, proximity reach can be around participant client device 102. Proximity reach 152 can have any measurement in metric or non-metric units. In some preferred embodiments, proximity reach 152 can be measured by latitude-longitude increments, latitude-longitude-altitude increments, latitude-longitude-direction increments, latitude-longitude-altitude-direction increments, or any combination thereof. For example, proximity reach 152 can be five feet. A benefit of proximity reach 152 is to enhance a level of imprecision so that when trying to obtain 504 digital artifact 100, participant client device 102 need not precisely match exactly the coordinates of digital artifact 100. In an embodiment, there can be a limitation of proximity reach 152 by direction 170; thus, proximity reach 152 may require participant client device 102 to face a certain direction. A benefit of proximity reach 152, or additionally, requiring direction 170 can be to ensure that a person sees certain things, places, or persons near a physical location (by way of non-limiting example, advertisements) around the time of interacting with digital artifact 100. However, direction 170 is not a prerequisite to realizing this benefit. In most preferred embodiments, proximity reach can be lesser in scope than proximity detector 150.

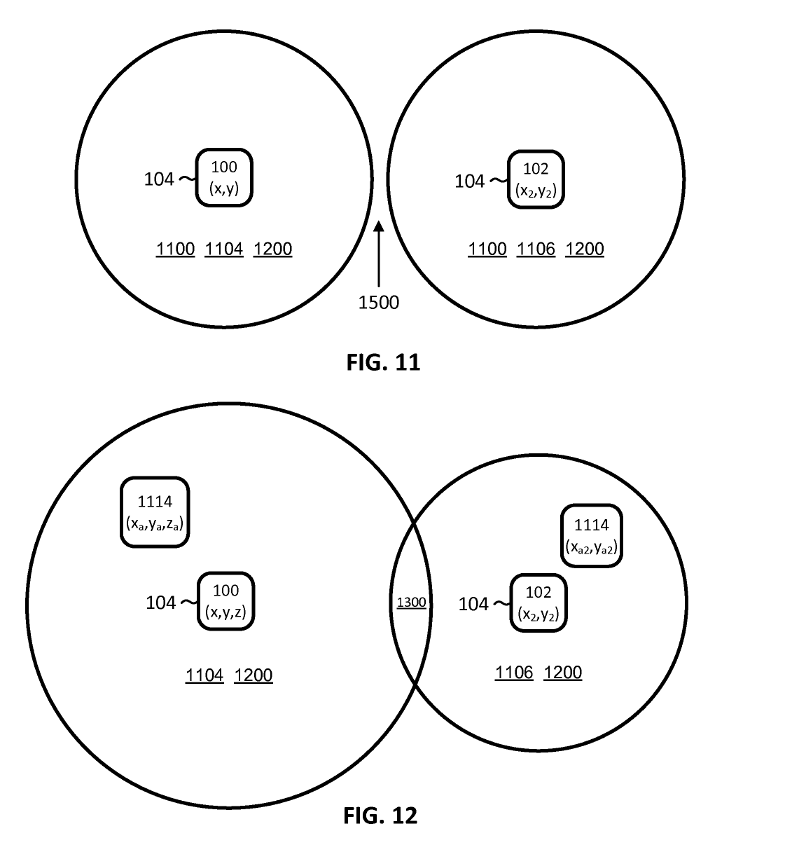

Radius 154 (r) can be a numeric value. Radius 154 can affect proximity reach 152. In embodiments with accuracy assignment 1100, or zones 1104, 1106, or 1200, radius 154 can be used to calculate the given coverage, which can help determine whether there is juxtaposition of proximity zones 1300 (FIGS. 11-18). Radius 154 can be used to calculate any zone or area, although 150, 152, 1100, 1104, 1106, and 1200 (FIG. 12). Radius 154 can have a round or non-round shape. Some non-limiting examples can include a bounding box, ellipse, bounded area, triangle, star, hexagon, pentagon, octagon, n-sided shape, geometric bounding area, irregular shape, or any form having two or more points, circle, sphere, round or non-round (FIG. 15C). In an embodiment, radius 154 or accuracy assignment 1100 can be calculated by numeric values. Diameter can be twice radius 154. In circular embodiments, radius can be substantially equal to the circumference divided by 2πr. Area can be calculated by A=πr². The space for a sphere can be calculated by S= 4/3πr³.

Proximity location 156 can be determined by latitude 158 and longitude 160. Proximity location 156 can be based on the location of digital artifact 100 or participant client device 102 at an unknown time and place. Proximity location 156 can be non-predetermined.

Latitude 158 and longitude 160 can be non-predetermined. In possible embodiments, latitude 158 and longitude 160 can be ascertainable by GPS coordinates at a given time, tower triangulation, or program interfaces, regardless of the type of operating system.

First location 162 and second location 164 can be predetermined or non-predetermined locations. Participant client device 102 can obtain 504 digital artifact 100 at first location 162 at an unknown time. Participant client device 102 can later release digital artifact 100 at second location 164. Participant client device 102 can be first user 166 that originally interacted with or provided digital artifact 100. Also, participant client device 102 can be second user 168 that later interacts with digital artifact 100.

Direction 170 can be established by mobile device 176 by pointing it in a given direction or by ascertaining its movement in time from a first point to a second point. A benefit of direction 170 can be to provide movement information in relation to objects in game 101, whether digital artifact 100 or other objects.

Tilt 172 can provide more detailed orientation in relation to other aspects of game 101. Tilt 172 can be established by a fluxgate compass. In an embodiment, tilt 172 can have an accelerometer or information thereof. Tilt 172 can provide horizontal, vertical, or angle orientation information. In a possible embodiment, together with direction 170, tilt 172 can allow game 101 to provide specific views customized to a given direction 170 and tilt 172 of participant client device 102. Server 140 or client 142 can calculate perspective information and communicate between them.

Set of locations 174 can be a list of locations. Set of locations 174 can have first location 162. In some preferred embodiments, first location 162 can be within set of locations 174 setting forth a list of locations, retail or non-retail, commercial or non-commercial, while second location 164 can be the same set of locations 174 or a different list of locations. By way of non-limiting illustration, first location 162 can be limited to select fast-food restaurant locations in a given area where digital artifact 100 can be picked up or released. A benefit of set of locations 174 can be to minimize risk of releasing digital artifact 100 in a location that is rarely visited or is not likely to be visited by other participants (by way of non-limiting illustration, a location within a large body of water). This limits possible release locations, although the actual location can still be non-predetermined since it can be unknown exactly where within set of locations 174 digital artifact 100 will be released. By preventing such frustration, the experience is thereby enhanced. Set of locations 174 can limit the latitude and longitude where participant client device 102 can drop digital artifact 100. In an embodiment, set of locations 174 can have predetermined location 105. In an embodiment, set of locations 174 can have non-predetermined location 104. First location 162 and second location 164 can be predetermined locations 104 or non-predetermined locations 104; in some preferred embodiments, locations within set of locations 174 can have predetermined locations 105 and non-predetermined locations 104. Set of locations 174 can have a subset of locations. In embodiments where first location 162 is not predetermined, set of locations 174 can also be non-predetermined in whole or in part. Set of locations 174 can have any number and combination of predetermined or non-predetermined locations. By having some predetermined locations and non-predetermined locations, set of locations 174 can provide more interesting interaction while balancing the need for directed commercial activity. Set of locations 174 can have multiple digital artifacts 100, multiple genetic material 304, or multiple tokens 400. Set of locations 174 can be defined by participant client device 102 or by game 101. Set of locations 174 can have a non-predetermined path 410.

Mobile device 176 can be any portable device with an operating system. In some preferred embodiments, mobile device 176 can have a fluxgate compass, accelerometer, GPS receiver, operating system, wireless network adapter, and user interface.

User profile 178 can be any information associated with participant client device 102, first participant client device 102, second participant client device 102, or any particular user. User profile 178 can be stored on server 140 or computing device 146. Users can be socially networked, including but not limited to participant client devices 102. The social networking can occur at any time. In some preferred embodiments, associations between users can occur when in proximity reach 152. User profile 178 can display information about participant client device 102, including but not limited to current location, path, clues about token 400, or other information.

Identifier 180 can be any designation, whether number, value, key, binary data, string, blob, clob, number, name, or otherwise, unique or non-unique. In most preferred embodiments, identifier 180 is a unique number associated with digital artifact 100. Identifier 180 can help distinguish digital imprint 100. In an embodiment, identifier 180 can use non-predetermined location 104, predetermined location 105, and a timestamp. Identifier 180 can be stored on server 140. Identifier 180 can also be stored on client application 142.

Asset 182 can be any object, digital or non-digital, associated with digital artifact 100. In many preferred embodiments, asset 182 can be a prize, whether monetary amount, prize, debt, award, coupon, voucher, credit, or other incentive. In an embodiment, asset 182 can be any element disclosed in this specification. In most preferred embodiments, digital artifact is associated with asset 182. Asset 182 can have an asset identifier. Asset 182 can be associated with more than one digital artifact 100, and vice versa. Asset 182 can be stored on server 140. Asset 182 can also be stored on client application 142.

FIG. 2 illustrates a possible embodiment of the present invention involving a trading card game. Card 200 is shown in FIG. 2 with limited number of drops 202, digital artifact 100, participant client device 102, non-predetermined location 104, predetermined location 105, boundary 130, and set of locations 174.

Card 200 can be digital artifact 100. Card 200 can have characteristics of a trading card. Card 200 can have any data 144, textual data, display information, formatting information, metadata, URLs, images, audio, video, html, xml, or other information, and in any combination. In a possible embodiments where digital artifact 100 is a card, participant client device 102 can trade card 200, buy or sell card 200, create card 200, alter 152 card 200, delete card 200, activate card 200, add comments to card 200, release 506 card 200, obtain 504 other participants' cards, or provide feedback.

Limited number of drops 202 can be a value limiting the number of times digital artifact 100 can be released. In an embodiment, participant client device 102 can be limited to releasing digital artifact 100 limited number of drops 202. By way of non-limiting illustration, game 101 can start with ten drops; thus, digital artifact 100 can only be released 504 in ten locations 104 or 105. In a possible embodiment, once limited number of releases 202 is triggered, fee 416 can be required to purchase more releases 504 or to recall a released digital artifact 100, here being card 200, by removing it from the location 104 or 105 where it was released 504. In a preferred embodiment, other participant client devices 102 can obtain 504 digital artifact 100 from any of the release locations an unlimited number of times. In a preferred embodiment, there can be a limit as to the number of cards 200 that can be obtained 504. In addition, once limited number of drops 202 is triggered, participant client device 102 can release another digital artifact 100, such as card 200, which was collected at an earlier non-predetermined location 104. This can add to the number of locations that card 200 can be obtained 504 without affecting the released 506 cards 200 available to the original card creator. This can remove card 200 from a participant's collection and thus free up a slot for them to collect another card 200. In an embodiment, limited number of drops 202 can be stored on server 140 or with client application 142, or both.

A method can comprise obtaining card 200, releasing card 200 in a non-predetermined location 104, and obtaining card 200 in the non-predetermined location. A method can comprise trading card 200 in a non-predetermined location where first participant 102 is in proximity with second participant 102.

FIG. 3 illustrates a possible embodiment of the present invention involving an evolution game. Area 300 is shown in FIG. 3 with creature 302, mingling 303, genetic material 304, attribute 306, digital artifact 100, game 101, participant client device 102, non-predetermined location 104, predetermined location 105, and set of locations 174.

Area 300 can have a digital representation of a fictional genetic material 304. In an embodiment, for example in evolution game embodiments, the present invention can provide for mingling 303 of digital artifacts in area 300. Participant client device 102 can go to area 300 by longitude and latitude and leave a digital artifact 100, token 400 or 400A. Area 300 need not be a predefined location. Area 300 can be defined as a space by a group of points having latitude and longitude. In an embodiment, area 300 can change over time.

Creature 302 can be created in game 101. In most preferred embodiments, participant client device 102 can control appearance of creature 302. Creature 302 can have one or more attributes 306. Creature 302 can be associated with genetic material 304. Each creature 302 in game 101 can have genetic material 304 that can be left in a location. In some preferred embodiments, creature 302 can have one or more images depicting an organic or non-organic being at any given stage of maturity, at or following conception. In most preferred embodiments, creature 302 can have a new appearance after genetic material 304 of first creature 302 is mingled 303 with second genetic material 304.

Mingling 303 can be automatically provided by game 101 of genetic material 304. In some preferred embodiments, mingling 303 can occur at area 300, whether by entering, passing through, or being proximate to area 300. Digital artifact 100 can be associated with creature 302. Further, digital artifact 100 can be genetic material 304 of first creature 302. Genetic material 304 can facilitate interaction with second creature 302 having second genetic material 304. In most preferred embodiments where game 101 is an evolution game, participant client device 102 can interact with genetic material 304. For example, participant client device 102 may obtain 504 genetic material 304 or be in proximity with genetic material 304 via juxtaposition of proximity zones 1300, thereby altering 512 their creature 302 having third genetic material 304. In a possible embodiment, images, graphics and animations corresponding to each successive creature can be selectively or randomly generated, or allow a user to control in part the use and design of third creature 302. In some preferred embodiments, to speed up game play, third creature 302 with attributes 306 and respective values thereof can be automatically generated by an administrator-selected, predetermined or non-predetermined, or created at random.

Genetic material 304 can be digital artifact 100. Participant client device 102 can leave genetic material 304 in area 300. In a possible embodiment, genetic material 304 can be an image representation of DNA which can be subject to mingling 303 at area 300 or in proximity with another creature 302. An at least one attribute 306 can be an at least one genetic material 304. In a preferred embodiment, participant client device 102 can have proximity reach 152 where genetic material 304 can be released or obtained.

Attribute 306 can be associated with creature 302. In a possible embodiment, unique parameters can be established representing attributes 306 of creature 302. In a possible embodiment, each can have range of values from 0-255 (preferably hex). In a possible embodiment, some non-limiting examples of attribute 306 can include: body size, body aspect shape, secondary body aspect shape, primary color, secondary color, number of eyes, shape of eyes, color of eyes, size of eyes, location of eyes, number of ears, shape of ears, size of ears, location of ears, amount of hair, length of hair, color of hair, style of hair, location of hair, number of limbs, location of limbs, length of limbs, number of limbs, shape of limbs, number of antennae, length of antennae, shape of antennae, location of antennae, shape of mouth, size of mouth, number of mouths, location of mouths, number of teeth, shape of teeth, location of teeth, shape of nose, size of nose, color of nose, number of noses, location of noses. Thus, if there are forty possible attributes 306, the possible combinations are finite and all variations can be prebuilt or dynamically built into a manageable set with corresponding graphics, video, audio, text, attribute augmentation, behavioral characteristics, and animation. If gradations are calculated simply by the number of attributes to the power of the number of attribute values, in this particular example, 40²⁵⁶, then it is possible to ascertain the exact number of possibilities. In a preferred embodiment, creature 302 can be mingled 303 with genetic material 304 of another creature 302. Time can be associated with attribute 306. In a preferred embodiment, an at least one attribute 306 can be genetic material 304 or a representation thereof.

FIG. 4 illustrates a possible embodiment of the present invention involving a scavenger hunt. Token 400 is shown in FIG. 4 with primary token 400A, winnings 406, value 408, non-predetermined path 410, time limit 412, locator 414, fee 416, and game 101.

Game 101, in a possible embodiment, can be a scavenger hunt. In a possible embodiment, commercial establishments can be involved. Further, in a possible embodiment, a release site location can only be one of a retail company's physical locations within set of locations 174 and thus digital artifact 100 can be limited so that it cannot be released anywhere on earth.

Token 400 can be displayed on computing device 146 or mobile device 176. Token 400 can be digital artifact 100. In an embodiment, digital artifact 100 can have token 400. In a possible embodiment, token 400 can represent a prize. In a possible embodiment, game 101 can be a scavenger hunt and participant client device 102 can obtain token 400. Token 400 can give participant client device 102 the right to obtain another token 400 in another scavenger location 104 or 105. In a possible embodiment, token 400 can be at a local coffee retailer. A user can then be required go to a retailer where token 400 can be located. Participant client device 102 can go to the location and obtain token 400 when locations of participant client device 102 and token 400 roughly match. Participant client device 102 can have proximity reach 152 where token 400 can be within reach. Participant client device 102 can get the prize and then can drop token 400 at another location. In a possible embodiment, token 400 starts at the intersection of 5^{th} and Main. The first ten participant client devices 102 that go to 5th and Main can pick up token 400. Further, those ten participant client devices 102 can drop the token 400 in ten new locations, a new location for each of them. After ten drop or after time elapse (whichever comes first), after a time elapse to drop a particular instance of token 400, a token 400 can be activated. That activated token 400 can be designated the primary token 400A. To facilitate user interaction, communications between participant client devices 102 can be initiated and received. In some preferred embodiments, participant client devices 102 can tell other participant client devices 102 where to pick up token 400.

Primary token 400A can be activated in game 101, and can represent the main prize. Primary token 400A can be selected from any of tokens 400. By way of non-limiting illustration, there can be a group of participant clients where ten participant client devices 102 can obtain token 400 where game 101 allows more than one participant client device 102 to pick up token 400. Then, the participating participant client devices 102 can release token 400 in ten new locations. Further, the other nine tokens 400 which were not changed to primary token 400A can have minor prizes. In a possible embodiment, primary token 400A can be randomly or selectively activated by the system from an earlier picked up token 400. Having primary token 400A can help maintain fair play by reducing the chance that participant client devices 102 monopolize token 400 or token 400A to keep the winnings. To reduce the chances of cheating, where there are multiple releases of token 400, no participant client knows the next location of the next primary token 400A. Similarly, after participant client devices 102 release their respective tokens 400 in various locations, those which are not the primary token can be deactivated or a subset of tokens can be activated as one or more secondary prizes. For example, the next primary token 400A can be randomly selected as the one released at Santa Monica Blvd and Wilshire. Primary token 400A can then be obtained and released, and subsequent or simultaneous activation of at least one primary token 400A can be randomly selected after it has been released, for example, at Ocean Park Blvd. and Lincoln Blvd. in the city of Santa Monica. This example is non-limiting.

Winnings 406 can be an amount of money, one or more prizes, information, or any combination thereof. Winnings 406, as the pot grows, can accumulate in multiple or successive rounds 500.

Value 408 can be associated with token 400 or digital artifact 100. In a preferred embodiment, value 408 can be a money value in any currency or representative of a physical or virtual prize such as merchandise, credits to purchase on a web site (e.g., iTunes gift card), or points awarded. In a possible embodiment, value 408 can be binary, or any complex or primitive data type capable of mathematical calculation, whether numeric, decimal, float, double, long, int, or money value in any currency. In a possible embodiment, each time token 400 can be released, a new round 500 can begin. If participant client device 102 wishes to participate in the new round 500, a fee 416 can be charged to participant client device 102. An accumulation of winnings 406 can be collected from all or a portion of fee 416 or charged separately to participant client device 102. For example, an additional ninety-nine cents can be accumulated in winnings 406 until after a number of rounds there can be an accumulated amount in treasure. Further, the digital artifact 100 can be released somewhere else, a second non-predetermined location 104 which can be associated with another instance of new round 500, which can iterate or multiply.

Non-predetermined path 410 can be a sequence of locations. Non-predetermined path 410 can be user-defined or generated by the system, selectively or randomly. Unlike treasure hunts in the related art, this allows flexibility and customization to the localized geographies of a given physical environment. Thus, in a possible embodiment, game 101 can adapt to a local neighborhood and shopping center.

Time limit 412 can provide a limit for releasing token 400. In an embodiment, time limit 412 can limit the length of time for participant 102 to release token 400, the length of round 500 or the length of time for game 101 as an overall time limit 412.

Locator 414 (shown in FIG. 4B) can provide assistance to locate token 400. Locator 414 can be one or more tools with user interfaces in computing device 146. Locator 414 can display proximity detector 150. Locator 414 can also display proximity reach 152. Locator 414 can be a radar. Message 506 can be provided to participant client device 102. Message 506 can be any form of expression, whether riddle, clue, image, audio, video, text or non-text or any combination thereof. Message can benefit participant client device 102 to help figure out the location of token 400. In a preferred embodiment, token 400 can be visible only when participant client device 102 is within physical proximity reach 152 of token 400. In a preferred embodiment, digital artifact 100 can be set in a random location. Client application 142 can provide a locator 414 as a map with proximity reach 200 or as a periodic radar ping.

Fee 416 can be any amount charged to participant client device 102. Fee 416 can be associated with an account of participant client device 102. Reduced fee 416 can be associated with token 400 or 400A.

In a possible embodiment, set of locations 174 can restrict game 101 by having a user-defined scavenger hunt. Scavenger hunt game 101 can have a user-defined starting point, first location 162. A clue can be provided, such as directional information, riddles, video, images, words, symbols, letters, directions, arrows, pointers, hand symbols, cursors, blinking indicators, coordinates, proximate location, area, or other indicators, direct or indirect, to locate the token 400.

In a possible embodiment, the first person can pick up the token 400. Further, participant client devices 102 can obtain token 400 until a maximum number B. After the first B participant client devices 102 obtain token 400, participant client device 102 can place token 400 in a new location, and the cycle can repeat.

In a possible embodiment, game 101 can randomly select one or more of the B tokens 400 that have been placed by participant client devices 102 to begin the next round 500. Time limit 412 can be specified to facilitate game play and allowing for the game to progress. For example, when first participant client device 102 picks up token 400, there can be a maximum time allowed C to place the token 400 at a new location. If the maximum time allowed C is exceeded then the game 101 could randomly place the token 400 at a new location, or other users could be allowed to place the token. A benefit of this approach is to ensure that the game play is not hindered or delayed, and to prevent a participant from stopping the round or game.

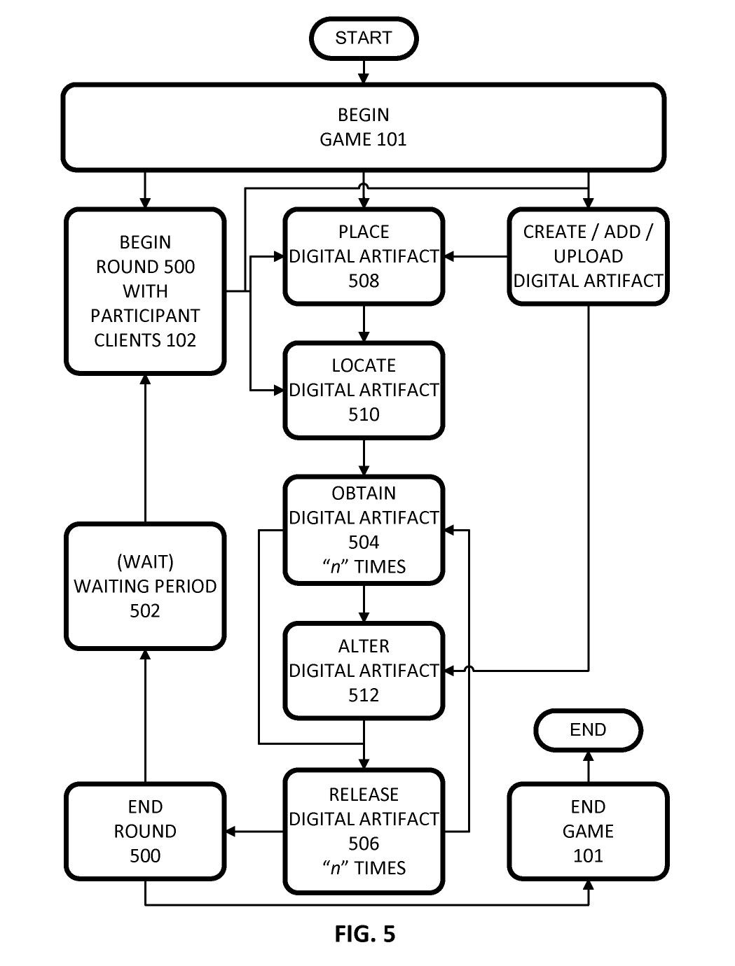

FIG. 5 illustrates a method diagram of a preferred embodiment the present invention. Round 500 is shown in FIG. 5 with waiting period 502, obtaining 504, releasing 506, placing 508, locating 510, and altering 512.

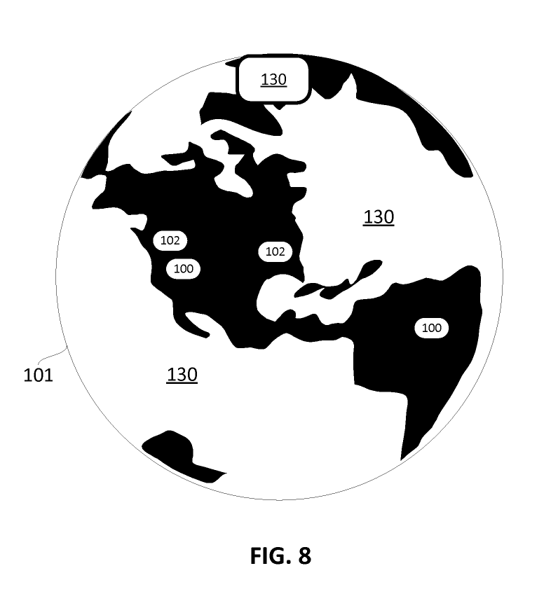

Round 500 can begin an instance of game 101. Game 101 can have one or more rounds 500. In a possible embodiment, game 101 can be played on computing device 146. In most preferred embodiments, game 101 can have mobile device 176 which communicates with server 140 via web service calls. In a preferred embodiment, game 101 can be operable twenty-four hours per day, seven days per week. Game 101 can be geographically universal in scope, e.g., worldwide, or limited to less than the world. FIG. 8 shows a possible embodiment where game can be worldwide and boundaries 130 can limit various locations while still leaving significant possible locations for non-predetermined locations 104. While game 101 operates, multiple participant client devices 102 can play in round 500.

Round 500 can first begin when worldwide game begins operation. When the token 400 is picked up by one or more participants, another round 500 can begin. Multiple rounds 500 can be running simultaneously, for example, in UK and in the United States. Round 500 can have a time limit. In a possible embodiment, time limit 412 for an instance of round 500 can be a preset amount of time. An administrator can set overall time limit 412. In a preferred embodiment, if no one wins, the prize can roll over to the next round 500 so that the prize accumulates. Where the prize is money, the amount can accumulate in larger amounts until a winner obtains the token 400. In a possible embodiment, five instances of game 101 can be concurrently running with an ever-growing pot of winnings. In another possible embodiment, game 101 can have prizes. Game 101 is not limited to the embodiments described herein and can have many variations. Game 101 can have a first non-predetermined location and a second non-predetermined location having a second unknown longitude and a second unknown latitude. Game 101 can allow participant client device 102 to leave digital artifact 100 with digital information that other participant client devices 102 can interact with. In an embodiment, round 500 can be started or concluded upon obtaining digital artifact 100.

Waiting period 502 can occur before round 500. In a possible embodiment, waiting period 502 between successive rounds 500, for example, 24 hours. With waiting period 502, time can be provided between finding token 400 and when token 400 is placed in second non-predetermined location 104. If no one finds token 400 and no one moves token 400, then overall time limit 412 can expire; at such expiration, the system can randomly select a new location for token 400 and either continue or start a new round 500.

Some non-limiting methods for interacting with digital artifact 100 are described below in obtaining 504, releasing 506, placing 508, locating 510, and altering 512. As noted in this specification, digital artifact can be card 200, creature 302, token 400, or otherwise; therefore, such methods can apply, with variation. These methods can be supported structurally, by way of non-limiting illustration, by computing device 146 and server 140 wherein communication to server 140 can occur at the time such method is performed. The present invention is not limited to any particular brand or SDK or operating system. One of ordinary skill in the pertinent art would know how to use a SDK that incorporates the elements of the present invention including the methods described herein.

Obtaining 504 can be performed on digital artifact 100. Digital artifact 100 can become associated with participant client device 102 that obtains 504 given digital artifact 100. In an embodiment, digital artifact 100 can become disassociated with a prior participant client that released 506 the instant digital artifact 100. By obtaining 504 digital artifact 100, this can facilitate relocating of digital artifact 100. In some preferred embodiments, obtaining 504 can occur within set of locations 174. Obtaining 504 can occur when participant client device 102 is within proximity of digital artifact 100. In most preferred embodiments, obtaining 504 occurs only when proximity reach 152 of participant client device 102 includes the location of digital artifact 100. Identifier of digital artifact 100, non-predetermined location 104, and action of obtaining 504 can then be sent to server 140. One of ordinary skill in the art would know how to incorporate obtaining 504 in the present invention, as well as releasing 506, placing 508, and altering 512. By way of non-limiting illustration, in the Apple iPhone SDK there are libraries and methods for selecting an image, obtaining a location, and making web service calls. In an embodiment, obtaining 504 can occur with respect to title or ownership of digital artifact 100 without having possessory movement to relocate digital artifact until later coming into proximity with digital artifact 100 to obtain 504 in order to relocate it by subsequently releasing 506. In a possible embodiment, obtaining can include first location 162 of digital artifact 100.

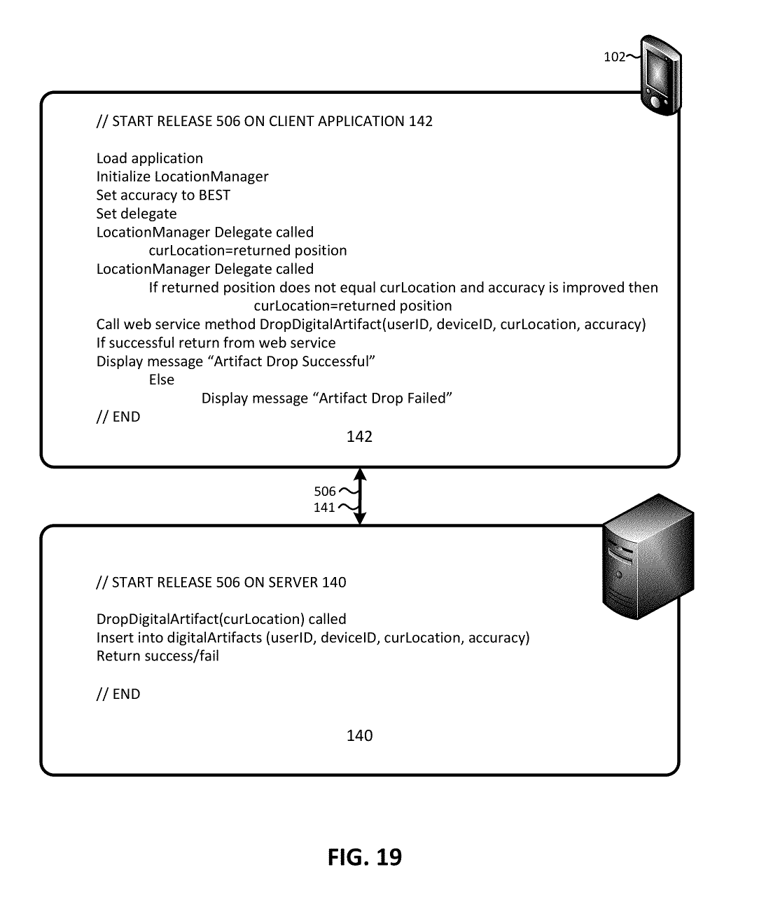

Releasing 506 can be performed on digital artifact 100. Digital artifact 100 can become disassociated with movement of participant client device 102 having performed releasing 506. In an embodiment, digital artifact 100 can be released by participant client device 102 in non-predetermined location 104 or predetermined location 105. In most preferred embodiments, releasing 506 can occur in a new non-predetermined location 104 after obtaining 504 in a prior location. In most preferred embodiments, a subsequent participant 102 can re-release 506 in a new non-predetermined location 104, or at a location within set of locations 174. In most preferred embodiments, participant client device 102 after having performed releasing 506 cannot move digital artifact 100 to a new location. In a preferred embodiment, releasing is done by issuing a command on computing device 146. In an embodiment, releasing can include placing 508. In a possible embodiment, releasing can include parameters for non-predetermined location 104 (including latitude 158 and longitude 160) and digital artifact 100. The latitude 158 and longitude 160 can correspond to second location 164. By way of non-limiting illustration, release 506 can be performed on computing device 146 or mobile device 176, such as Apple iPhone as client 142 (FIG. 19).

```
// START
Load application
Initialize LocationManager
Set accuracy to BEST
Set delegate
LocationManager Delegate called
    curLocation=returned position
LocationManager Delegate called
    If returned position does not equal curLocation and accuracy is
            improved then curLocation=returned position
Call web service method DropDigitalArtifact(userID, deviceID,
curLocation, accuracy)
If successful return from web service
Display message “Artifact Drop Successful”
    Else
        Display message “Artifact Drop Failed”
// END
```

Further, by way of non-limiting illustration, the following can facilitate releasing 506 of digital artifact 100 via server 140 (FIG. 19).

// START
DropDigitalArtifact(curLocation) called
Insert into digitalArtifacts (userID, deviceID, curLocation, accuracy)
Return success/fail
// END

Placing 508 can be performed, i.e., to place digital artifact 100 at a location. Placing 508 can occur in non-predetermined location 104 or predetermined location 105. The location of digital artifact 100 can be defined randomly or selectively by game 101. In an embodiment, initial placing 508 of digital artifact 100 can be done randomly at the beginning of game 101 or round 500. In an embodiment, placing 508 can be done randomly or in combination with predetermined location 105 within set of locations 174. Placing 508 can be performed on digital artifact 100 after it is created, obtained, altered, or released.

Locating 510 can be performed, i.e., to locate digital artifact 100. This can include searching with or without assistance of client application 142. Locating 510 can be done with or without proximity detector 150 or proximity reach 152. Locate 510 can be performed on computing device 146, by way of non-limiting illustration, on Apple iPhone to perform locating 510:

```
// START
Load application
Initialize CLLocationManager
Set accuracy to BEST
Set delegate
CLLocationManager Delegate called
    curLocation=returned position
CLLocationManager Delegate called
    If returned position does not equal curLocation and accuracy is
            improved then curLocation=returned position
Call web service method LocateDigitalArtifact(curLocation, accuracy)
Display artifacts returned from web service
// END
```

Further, by way of non-limiting illustration, server 140 can allow locating 510 as follows:

// START
LocateDigitalArtifact(curLocation, accuracy) called
proximity=accuracy
daProximity=accuracy of digitalArtifact
Select * from digitalArtifacts where daProximity of artifactLocation in
proximity of curLocation
Return recordset
// END

Altering 512 of digital artifact 100 can be performed. In most preferred embodiments, alteration 512 can be creating, editing, adding to, publishing, providing feedback, annotating, nudging, moving, deleting, or updating. Alteration 512 can be performed on any asset or object in game 101. Alteration can be combining more than one digital artifact 100. Combining can occur where one or more digital artifacts 100 are left in area 300 so that they are concurrently present, or through the collection of multiple digital artifacts 100 in multiple locations over the course of the game 101. In a possible embodiment, ten participant client devices 102 can pass through area 300 and leave digital artifact 100 therein, and eleventh participant client device 102 having eleventh creature 302 can enter area 300. Then, eleventh creature 302 can be altered 512 by the combination of all of the other ten digital artifacts 100 in that area 300. Further, eleventh participant client device 102 can leave an eleventh digital artifact 100. In a preferred embodiment, digital artifact 100 can be a digital representation of a form of genetic material 304. There can be a “primordial soup” in a given area 300 where various digital artifacts 100 are in different physical areas 300. In a possible embodiment, if participant client device 102 goes to area 300, participant client device 102 can pick up digital artifact 100 or genetic material 304 and leave another digital artifact 100, plus mingling 303 of all those who were there before. In a possible embodiment, alteration 512 can be changing location of digital artifact 100. The first participant client device 102 to the first location 162 can obtain the token, while other participant client devices 102 who get there later do not get to obtain the token. In most preferred embodiments, participant client device 102 can modify or add to information left for the user and associated with the digital artifact; In an embodiment, digital artifact 100 itself. In some preferred embodiments, participant client device 102 having proper permissions may also redact or delete such information. In a possible embodiment, modifying can include editing a document and then releasing the document in a new location.

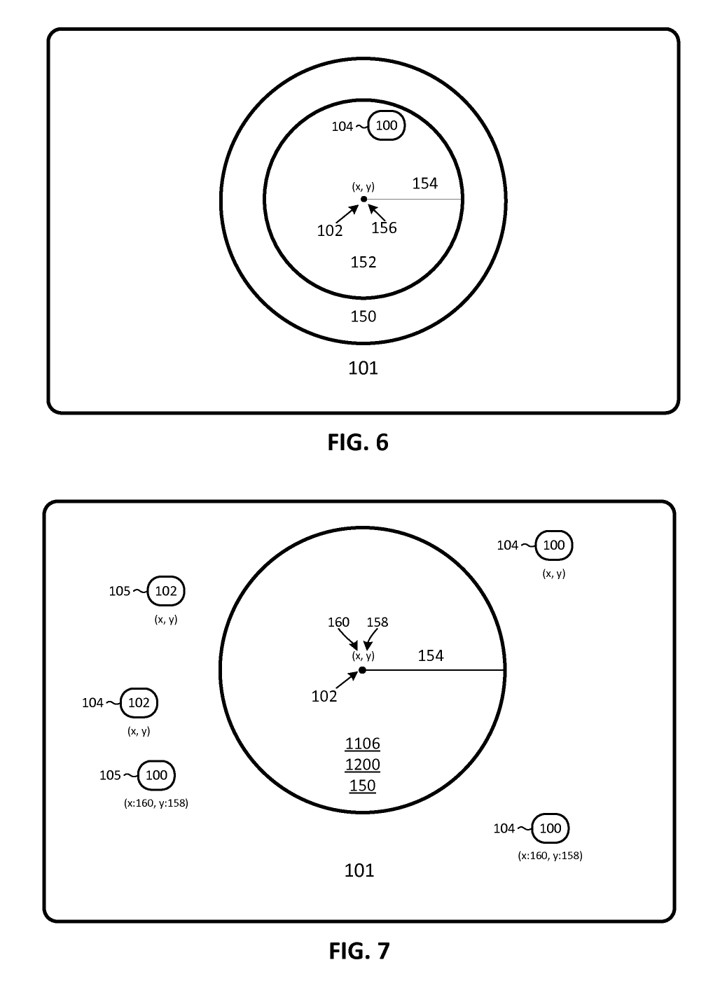

FIG. 6 illustrates a possible embodiment of the present invention. Digital artifact 100 is shown in FIG. 6 with game 101, participant client device 102, non-predetermined location 104, proximity detector 150, radius 154 applied to proximity detector 150, and proximity location 156.

FIG. 7 illustrates a possible embodiment of the present invention. Digital artifact 100 is shown in FIG. 7 with game 101, participant client device 102, non-predetermined location 104, proximity detector 150, proximity reach 152, and radius 154.

FIG. 8 illustrates a possible embodiment of the present invention. Game 101 is shown in FIG. 8 with out of bounds areas 130. Game 101 need not be worldwide, but in some embodiments it is conceivable that releasing and obtaining digital artifacts 100 can occur throughout the world.

FIG. 9 illustrates a possible embodiment of the present invention. Server 140 is shown in FIG. 9 shows with client application 142, with participant client device 102, computing device 146, mobile device 176, user profile 178, obtaining 504, releasing 506, placing 508, locating 510, and altering 512. In a preferred embodiment, communication occurs via Internet.

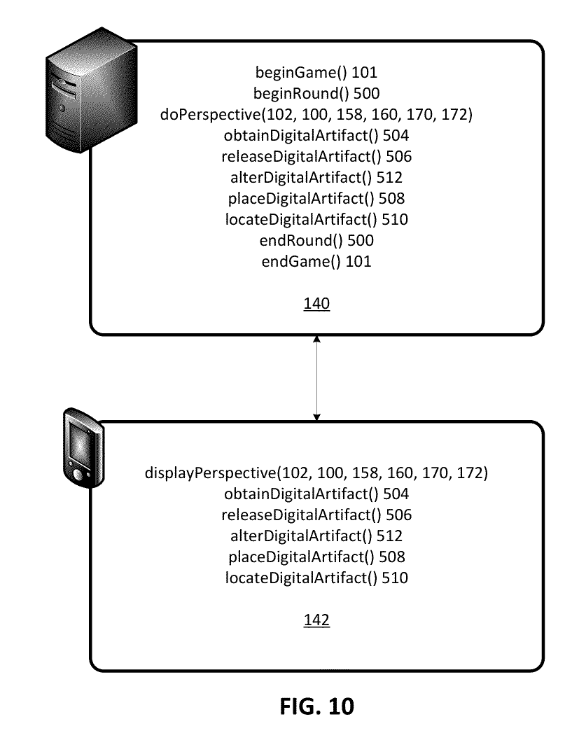

FIG. 10 illustrates an interaction scheme of a possible embodiment of the present invention. Server 140 is shown in FIG. 10 with client 142 including pseudo-code interfaces to conduct actions such as obtaining 504, releasing 506, placing 508, locating 510, and altering 512, as well as such actions involving digital artifact 100, game 101, participant client device 102, latitude 158, longitude 160, direction 172, tilt 172, and round 500. The present invention is not limited to this illustration.

FIG. 11 illustrates a proximity aspect of a possible embodiment of the present invention. Accuracy assignment 1100 is shown in FIG. 11, with list of proximate digital artifacts 1102, accuracy assignment zone of digital artifact 1104, accuracy assignment zone of searching device 1106, gap 1500, digital artifact 100, participant client device 102, and non-predetermined location 104.

Accuracy assignment 1100 can be in a unit of measurement or string description in any axis. By way of non-limiting illustration, the Apple iPhone provides a “horizontal accuracy” in meters. In a possible embodiment, location 104 or 105 and associated accuracy assignment 1100 can be stored in a database on server 140. In a preferred embodiment, digital artifact 100 can have location as well as accuracy assignment 1100 from the participant client device 102 that dropped digital artifact 100. Accuracy assignment 1100 can be assigned to any object in game 101. Accuracy assignment 1100 can affect the effectiveness of proximity detector 150 or proximity reach 152. A benefit of accuracy assignment 1100 is in providing dynamic adjustment depending on the quality of the location capabilities of both 1. releasing participant client device 102 of the digital artifact 100 and 2. searching device 102. This can provide a more enjoyable experience, because it generally reflects the original intent of both the dropper and the searcher. Searching device 102 need not necessarily release 506 the digital artifact 100. Another benefit of accuracy assignment 1100 is that it levels the playing field for users of lower-end or older devices 146 or 176 that may rely on less accurate methods for determining location and higher-end or newer devices 146 or 176 that may have sophisticated GPS positioning capabilities for extremely accurate location determination. Hence, accuracy assignment 1100 can allow old and new devices 146 or 176 to participate together by equalizing the technical limitations of the older devices, whether limited by the device software or hardware. FIG. 11 shows a non-overlapping range where participant client device 102 and digital artifact 100. In such case, it is possible that the device 102 does not detect digital artifact 100.

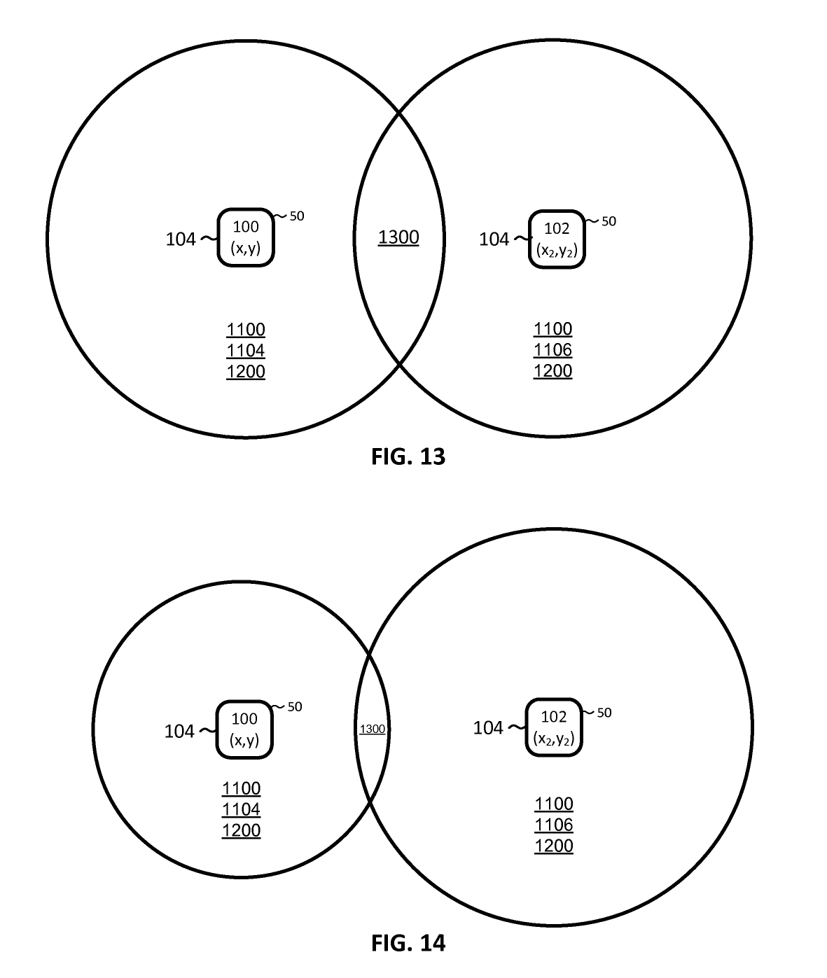

In a preferred embodiment, when a participant client device 102 attempts to locate 510 proximate digital artifacts 100, a current location 104 or 105 as well as accuracy assignment 1100 for participant client device 102 can be passed to server 140. This can occur, by way of non-limiting example, by a web service call. In a preferred embodiment, server 140, participant client device 102, or client application 142 can search based on accuracy assignment 1100 of digital artifact 100. Accuracy assignment 1100 of digital artifact 100 can be stored on server 140, as well as accuracy assignment 1100 of the participant client device 102 requesting a list of proximate digital artifacts 1102. In some preferred embodiments, each search can be unique based on the accuracy assignment 1100 of both digital artifact 100 and the participant client device 102. By way of non-limiting example, Device P (102) can have an accuracy assignment 1100 of 300 feet. If Device P (102) can release 506 digital artifact 100 at point x:100, y:100. Device Q (102) has an accuracy assignment 1100 of 30 feet. Device Q (102) can then initiate locating 510 digital artifacts 100 at point x:75, y:75. If a standard algorithm is used whereby a set radius helps calculate accuracy assignment zone 1200 around Device Q of 10 feet, then digital artifact 100 released by Device P would be missed because of the lesser accuracy of Device P. For example, FIG. 11 shows non-overlapping zones, and FIG. 15 shows proximity gap 1500. However, because the accuracy of both the releaser device 102 and the searcher device 102 can be used, Device Q can find the digital artifact 100 of Device P 102. Radius 154 can be based on the individual accuracy assignment 1100 of the digital artifact 100 (1104) can be drawn, e.g., formed 2102. Further, radius 154 can be based on the individual accuracy assignment 1100 of device 102, in this case Device Q having zone 1106, can be drawn (e.g., formed 2104) substantially around device 102. The areas intersecting can be considered “proximate.” A possible embodiment is shown in juxtaposition of proximity zones 1300 (FIG. 13). Further, by way of non-limiting illustration, see FIGS. 11-18 with reference to some possible embodiments.

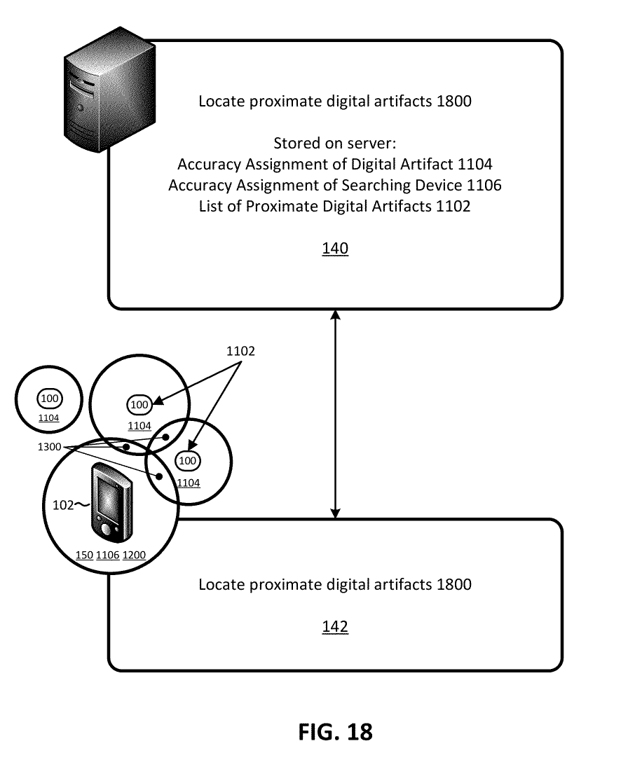

List of proximate digital artifacts 1102 (FIG. 18) can have any number of digital artifacts 100 in proximity with both digital artifacts 100 and participant client device 102. List of proximate digital artifacts 1102 can be sent from server 140 to participant client device 102 upon request by participant client device 102.

Accuracy assignment zone of digital artifact 1104 can be passed in real-time or stored on server 140 (FIG. 18). Accuracy assignment zone of digital artifact 1104 can be a detectable zone beyond the location of digital artifact 100. Accuracy assignment zone of digital artifact 1104 can be set to a value that can be used to calculate accuracy radius 1110, to find the detectable zone. In some preferred embodiments, a detectable zone embodied by accuracy assignment zone 1200 can be formed substantially around the digital artifact. The zone around digital artifact 100 can be based on its accuracy assignment zone 1200, which can be calculated from its accuracy radius 1110. Accuracy assignment zone of digital artifact 1104 can be accuracy assignment zone 1200.

Accuracy assignment zone of searching device 1106 can be passed in real-time or stored on server 140 (FIG. 18). Accuracy assignment zones 1200, 1104, or 1106 or can be searchable zones beyond, extending from, elliptically surrounding, peripheral to, peripherally encircling, squaring a grid, or geometrically expanded beyond a precise point-based coordinate location of a searching device, such as participant client device 102. Accuracy assignment zone of searching device 1106 can be accuracy assignment zone 1200.

Accuracy radius 1110 can be a distance from a location of digital artifact 100 or participant client device 102. Digital artifact 100 or participant client device 102 can have its own accuracy radius 1110, which can be used to calculate accuracy assignment zone 1200, 1104, or 1106. In an embodiment, a non-elliptical area can be provided such as a square that adds or subtracts from a given location (x, y). Accuracy radius 1110 can be radius 154 and its characteristics. FIGS. 15 and 15B show accuracy radius 1110 as radius 154 resulting in differing magnitudes for accuracy assignment zones 1200, also shown as 1104 (in relation to digital artifact 100) and 1106 (in relation to participant client device 102).

User-defined location 1114 (FIG. 12) can change a defined location of participant client device 102, or digital asset 100. In situations where a device 102, 146, or 176 has no accuracy assignment associated therewith, allowing a user to define such location can increase accuracy. User-defined location 1114 can facilitate designating a more precise location. A benefit of user-defined location 1114 is to enhance game play while decreasing frustration when interacting with digital artifacts 100. A problem with older devices is that some do not have high accuracy with respect to device location, which may result in a range of, for example, 300 feet within a given location. In such situations, there can be a wide area in which the device is actually located. Newer devices tend to have higher location accuracy. Generally, more accurate devices may in some cases provide very high accuracies from a given location. User-defined location 1114 can be set within accuracy assignment zone 1200. FIG. 12 shows a change from location (x,y,z) to (xₐ,yₐ,zₐ) for digital artifact 100 within 1104, and device 102 at (xₐ,yₐ) setting user-defined location 1114 to (xₐ₂,yₐ₂) within 1106. In some preferred embodiments, user-defined location 1114 can be set for the location of participant client device 102. In some preferred embodiments, user-defined location 1114 can be set by server 140 with a default value. In an embodiment, user-defined location 1114 can be set by participant client device 102, for example, via client application 142 running on participant client device 102. User-defined location 1114 can be set via a user interface on client application 142 which can display accuracy assignment zone 1200 (FIG. 12). User-defined location 1114 can be limited to locations within accuracy assignment zone 1200. By limiting the possible range of user-defined locations, a user in one geographic area cannot set their user-defined location 1114 in a remote geographic area. A benefit is to enhance honesty and integrity in locations so that players cannot usurp digital artifacts 100 by entering false locations. Further, security and encryption measures can be employed in combination, including without limitation the type of device, session identifier, user identifier, software identifier, proprietary hash, timestamp, browser type, operating system, browser user-agent, or any combination thereof. Accuracy assignment-related settings, in most preferred embodiments, can be done by an administrator setting on server 140. In an embodiment, there can be varying gradations of accuracy with respect to a given device or artifact, described by words, letters, numbers, or symbols. Some non-limiting examples can be: good, better, best, fair, poor, bad, high, medium, low, none, or any numeric value, or any combination thereof. Vertical or horizontal bars, incremental graphic pixels, or other symbolic representations can indicate accuracy. If there is no accuracy level assigned, a default level of accuracy can be set. Any of the gradations of accuracy can have numeric values. A non-limiting example can provide: “best” can be 5 feet, “good” at 15 feet, and “fair” can be 30 feet.

FIG. 12 illustrates a proximity aspect of a possible embodiment of the present invention. As shown in FIG. 12, where participant client device 102 has a large accuracy assignment zone 1200, overlapping with accuracy assignment zone 1200 of digital artifact 100 to form juxtaposition of proximity zones 1300. User-defined location 1114 is also shown in FIG. 12 within accuracy assignment zone 1200, which can occur in non-predetermined location 104.

Accuracy assignment zone 1200 can be an area around digital artifact 100 or participant client device 102. Accuracy assignment zone 1200 can be in any axis, for example: x, y, z, or any combination thereof. The combination of both accuracy assignments for digital artifact 100 and participant client device 102 can provide flexibility in game play as well as device manageability. In FIG. 11, there is no overlap between the accuracy assignments of digital artifact 100 and participant client device 102. As shown by way of non-limiting illustration in FIG. 11, the searching device, participant client device 102, does not detect digital artifact 100 since neither digital artifact 100 nor the area 1112 around it is within the accuracy assignment zone 1200. It will be understood that “accuracy assignment zone 1200” can also be referred to as “detectible area” or “area capable of being detected” with respect to digital artifact 100. Digital artifact 100 can also have a searching area. It will be understood that “accuracy assignment zone 1200” can also be referred to as “area capable of being searched” with respect to participant client device 102. Participant client device 102 can also have a detectible area. Accuracy assignment zone 1200 can be used to form zones 1104 or 1106.

In a possible embodiment, a low accuracy assignment 1110 can be given to participant client device 102 resulting in a large accuracy area 1112 for participant client device 102. A high accuracy assignment 1110 can be assigned to digital artifact 100; digital artifact 100 can thus have a small accuracy area 1112. Digital artifact 100 and participant client device can each have a non-predetermined location 104.

FIG. 13 illustrates a proximity aspect of a possible embodiment of the present invention. Juxtaposition of proximity zones 1300 is shown in FIG. 13 with accuracy assignment 1100, accuracy assignment zone of digital artifact 1104, accuracy assignment zone of searching device 1106, digital artifact 100, participant client device 102, and non-predetermined location 104.

Juxtaposition of proximity zones 1300 can be an overlap of two or more accuracy assignment zones 1100, 1200, 1104, or 1106. Participant client device 102 can be the searching device. A plurality of participant client devices 102 can have juxtaposition of proximity zones 1300. In an embodiment, participant client device 102 can locate another participant client device 102 via juxtaposition of proximity zones 1300. Also, therefore, digital artifacts 100 can detect another digital artifact 100.

FIG. 14 illustrates a proximity aspect of a possible embodiment of the present invention. Juxtaposition of proximity zones 1300 is shown in FIG. 14, with digital artifact 100 and participant client device 102. To provide a non-limiting illustration, FIG. 14 demonstrates a benefit of accuracy assignment 1100 applied to locating 510. If digital artifact 100 and participant client device 102 are at the same respective locations shown in FIG. 11, accuracy assignment zone of digital artifact 1104 with a small area can still be detected by participant client device 102 having a large assignment area of searching device 1106, producing proximity area 1300. As shown in FIG. 14, in a possible embodiment, accuracy assignment zone of searching device 1106 can be a larger area than that of digital artifact 1104.

FIG. 15 illustrates a proximity aspect of a possible embodiment of the present invention. Proximity gap 1500 can be a short distance between accuracy assignment zones 1100. Note the presence of juxtaposition of proximity zones 1300 between locations 1 and 2 in FIG. 15 which overlap, whereas between 3 and 4 there is no overlap and thus no juxtaposition of proximity zones 1300. Therefore, in most preferred embodiments, digital artifact 100 (FIG. 15 at x₃, y₃) would not be displayed on participant client device 102 with the smaller accuracy assignment, or with the smaller accuracy assignment zone of digital artifact 1004. Radius 154 can be the value of accuracy assignment 1100, and can be used to calculate any zone of any accuracy assignment 1100, zone 1200, 1104 or 1106.

FIG. 15B illustrates a proximity aspect of a possible embodiment of the present invention. A plurality of participant client devices 102 (“n” number of participant client devices 102) can be present. There can be first participant client device 102 (x, y), second participant client device 102(x₂, y₂), third participant client device 102 (x₃, y₃), and fourth participant client device 102 (x₄, y₄), without limitation.

FIG. 15C illustrates a proximity aspect of a possible embodiment of the present invention. Accuracy assignment zones 1200, whether applied to 1104 or 1106, can have varying shapes.

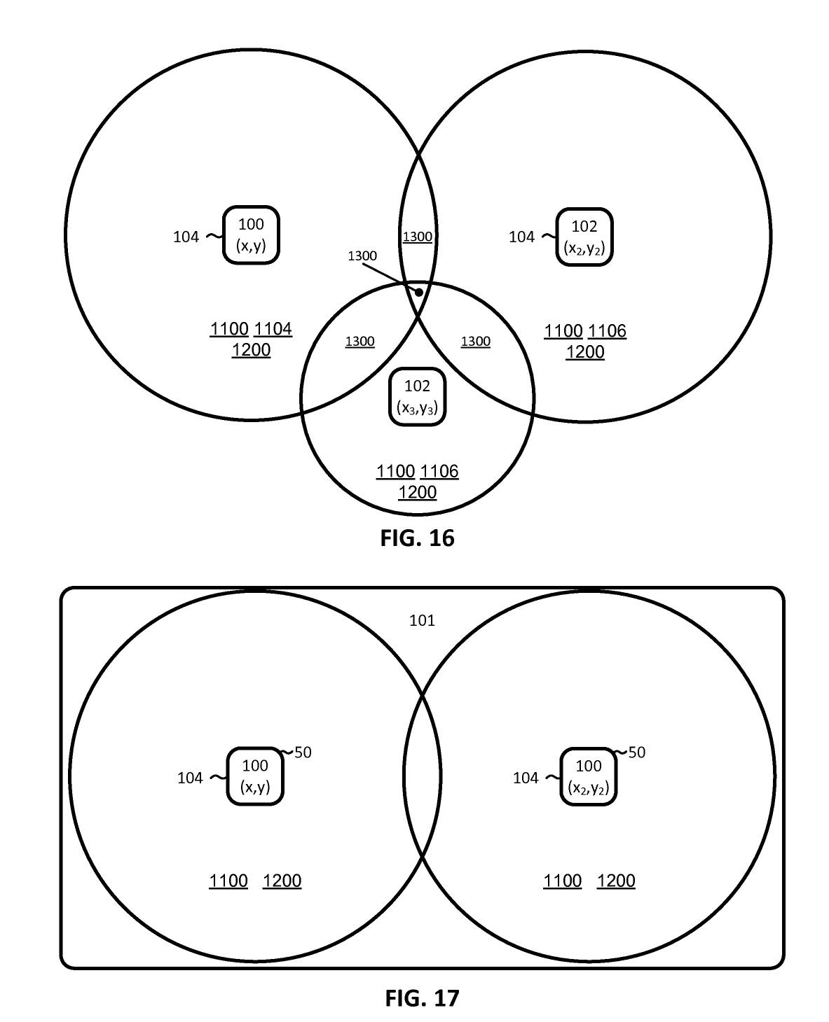

FIG. 16 illustrates a proximity aspect of a possible embodiment of the present invention. As shown in FIG. 16, a plurality of participant client devices 102 with respective accuracy assignments 1110 can be proximate to each other (FIG. 16), and can also be proximate to one or more digital artifacts 100 (FIG. 15). Further, participant client device 102 can be in proximity 1300 with accuracy assignments of digital artifact 1104 (FIG. 15). In a possible embodiment, a plurality of devices 102 can use the same process to locate 510 via accuracy assignment 1100, or more specifically, via accuracy assignments of searching devices 1106, respectively.

FIG. 17 illustrates a proximity aspect of a possible embodiment of the present invention. A plurality of digital artifacts 100, shown in FIG. 17, can be in game 101. Each digital artifact 100 can have a different or same accuracy assignment 1100. Game 101 can be displayed in a user interface of participant client device 102.

FIG. 18 illustrates a possible embodiment of the present invention. Locate proximate digital artifacts 1800 is shown in FIG. 18, with plural digital artifacts 100 having accuracy assignments 1104 respectively, participant client device 102 with accuracy assignment 1106, client application 142 and server 140. Proximity detector 150 is shown with accuracy assignment 1110. Locate proximate digital artifacts 1800 can be a web service call to server 140 with the location and accuracy assignment 1100 of participant client device 102. A web service call can get locations of digital artifacts 100 which are proximate 1300 to participant client device 102 using both accuracy assignment of searching device 1106 in combination with accuracy assignment of digital artifact 1104. Proximity detector 150 and accuracy assignment of searching device 1106 can coincide in shape. Accuracy assignments of digital artifacts 1104 can vary and need not be uniform for all digital artifacts 100. In some preferred embodiments, each digital artifact 100 can have its own accuracy assignment 1100 or 1104.

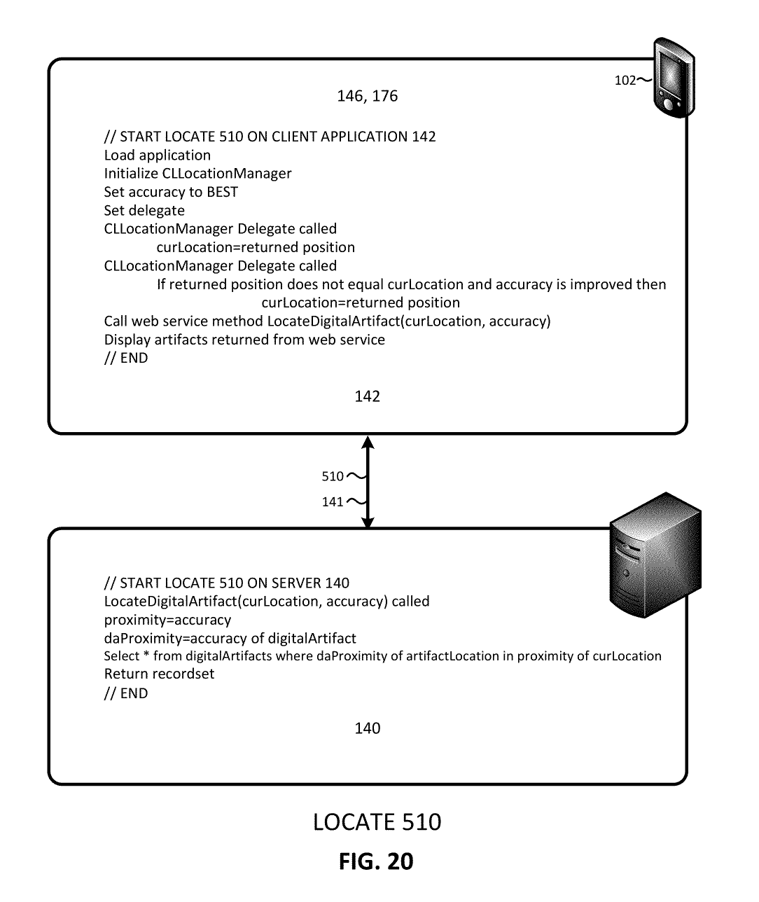

FIGS. 19 and 20 illustrate possible embodiments of the present invention. Release 506 is shown in FIG. 19 running on client application 142 and server 140. Locate 510 is shown in FIG. 20 running on client application 142 and server 140.

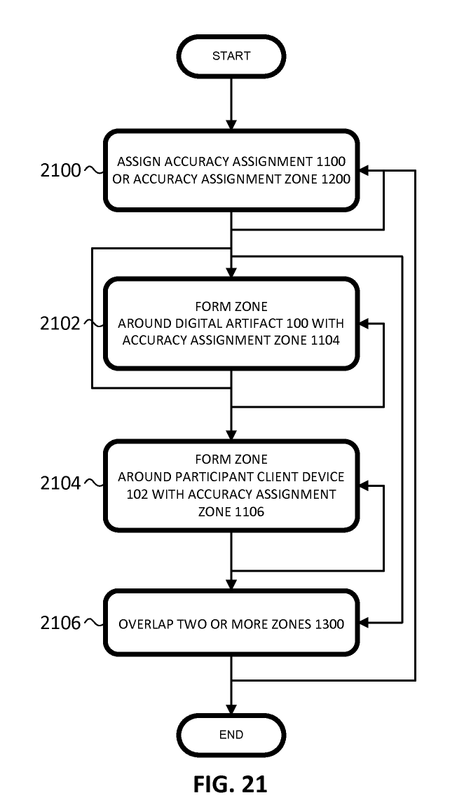

FIG. 21 illustrates a method diagram of a preferred embodiment the present invention. Assign 2100 can set an accuracy assignment 1100 to an object, and calculate an accuracy assignment zone 1200 substantially around an object, such as participant client device 102 or digital artifact 100. There can be multiple assignments 1100 to multiple objects 50, including by way of non-limiting illustration: card 200, creature 203, genetic material 304, token 400, and primary token 400A which can inherit characteristics from digital artifact 100. Assigning 2100 accuracy assignment zone 1200 can be performed on digital artifact 100. Assign 2100 can allow the object 100 or 102 to be discoverable by one or more participant client devices 102, where digital artifact 100 comprises a location 104 or 105, by forming 2102 a detectable zone 1200 substantially around digital artifact 100 based on the accuracy assignment zone 1200, or by forming 2104 a searching zone 1200 substantially around participant client device 102 with a second accuracy assignment zone 1200, and overlapping 2106 the accuracy assignment zone with the second accuracy assignment zone 1200, which can form juxtaposition of zones 1300. Accuracy assignment 1100, as noted herein, can be stored on server 140. Thus, 2100-2106 can be performed on server 140.

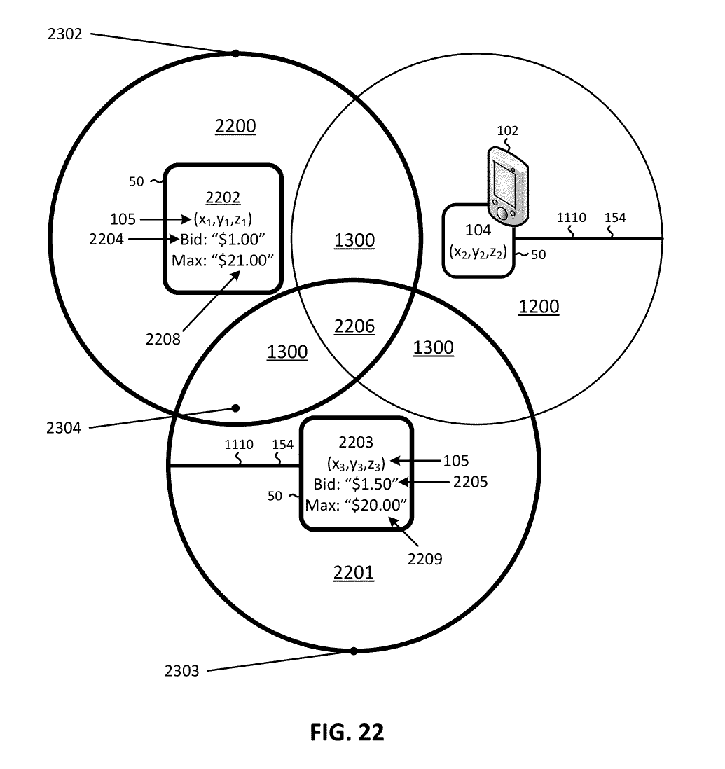

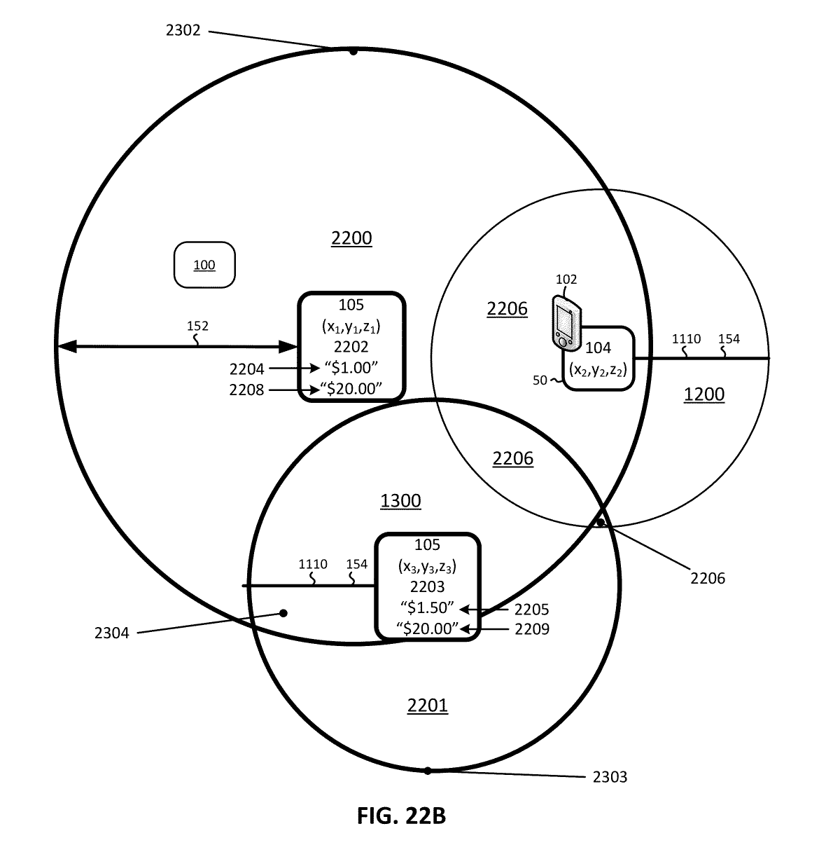

FIG. 22 illustrates a schematic diagram of an embodiment of the present invention. Proximity ad zones 2200 and 2201 are shown in FIG. 22, with object 50, participant client device 102 at non-predetermined location 104, accuracy assignment 1110, accuracy assignment zone 1200 in elliptical form, juxtaposition of proximity zones 1300, first advertisement 2202 at predetermined location 105, and second advertisement 2203 at another predetermined location 105, first bounding area 2302, second bounding area 2303, competing bid zone 2304, competing advertisement intersection zone 2206, first bid maximum 2208, and second bid maximum 2209.

FIG. 22B illustrates a schematic diagram of an embodiment of the present invention. In contrast to FIG. 22, FIG. 22B shows participant client device 102 inside proximity ad zone 2200. In a possible embodiment, participant client device 102 can be deemed “in” proximity ad zone 2200 if accuracy assignment zone 1200 intersects.

Proximity ad zone 2200 can refer to localized advertising space, defined by a two- or three-dimensional boundary around an advertisement. Proximity ad zone 2200 can be any shape, elliptical or non-elliptical, spherical or non-spherical. Participant client device 102 can be, but need not be, within a given proximity ad zone 2200. In an embodiment, participant client device 102 can be outside proximity ad zone 2200, yet participant client device 102 can receive an advertisement, for example, first advertisement 2202 or second advertisement 2203. Proximity ad zone 2200 can have three dimensions, and thus can be any three-dimensional shape. A non-limiting example of proximity ad zone 2200 can be a second floor of a shopping mall. Some further non-limiting examples of proximity ad zone 2200 can be a sphere, cube, block, or irregular shape. Proximity ad zone 2200 can be specified by coordinates. In some possible embodiments, proximity ad zone 2200 can have defined boundaries. In a possible embodiment, proximity ad zone 2200 can comprise accuracy assignment 1100 without an explicitly predefined boundary line or shape. In a possible embodiment, proximity ad zone 2200 can have a top plane, a bottom plane, and at least three sides. In a possible embodiment, proximity ad zone 2200 can have accuracy assignment 1100 without predefined planes. In a possible embodiment, proximity ad zone 2200 can have bounding lines defining a three-dimensional space. Proximity ad zone 2200 can be defined by a plurality of x, y, and z coordinates creating a closed shape. In a possible embodiment, proximity ad zone 2200 can be defined by an unclosed space within a larger predefined space, such as a wide area map. “Participant” with respect to advertisements can be opt-in or opt-out, either implicitly or explicitly. “Receiving” participant client device 102 in a given instance of proximity ad zone 2200 can be understood to mean that any data or information indicating that participant client device 102 is within the zone or proximate to the zone via its accuracy assignment zone 1200. Digital artifact 100 can be an advertisement within proximity reach 152.

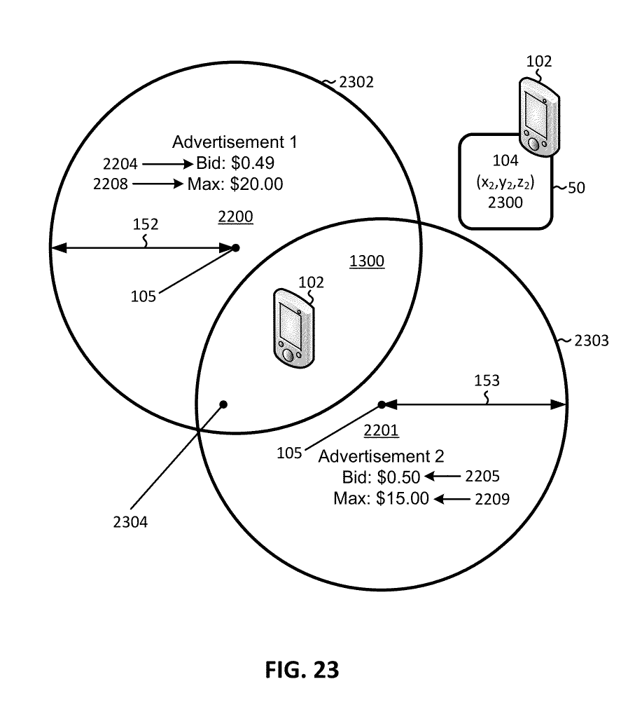

First advertisement 2202 can be any advertisement, for-profit or not-for-profit. First advertisement can be presented on participant client device 102 at non-predetermined location 104 or predetermined location 105. Second advertisement 2203 can be another distinct advertisement, whether or not created by the same advertiser as first advertisement 2200. Advertisement 2202 or 2203 can be a digital artifact 100. Advertisement 2202 or 2203 can be any image, text, sound, motion graphic, video, or combined images and sound on a mobile device. Each advertisement 2202 or 2203 can have a location associated therewith, whether predetermined location 105 or non-predetermined location 104. By way of non-limiting illustration, first advertisement 2202 can comprise one or more predetermined locations 105. In a possible embodiment, advertisement 2202 or 2203 can comprise a predetermined location 105 and a non-predetermined location 104. In a possible embodiment, advertisement 2202 or 2203 can comprise at least two non-predetermined locations 104. First proximity reach 152 (FIGS. 1 and 23) can be associated with first advertisement 2200. Further, second proximity reach 153 (FIG. 23) can be associated with second advertisement having second proximity ad zone 2201. Second location 104 or 105 can be associated with second advertisement and second proximity ad zone 2201. If second location 104 or 105 intersects with first proximity reach 152, then second advertisement having second proximity ad zone 2201 can have an ability to out-bid first advertisement having first proximity ad zone 2200, for example, by specifying a higher bid amount. Second advertisement having second proximity ad zone 2201 and its corresponding (second) bid amount 2205 can be compared to first bid amount 2204. The higher-bid advertisement can be shown if the participant client device 102 is in juxtaposition of proximity zones 1300, or more specifically when participant client device 102 is in proximity with a given proximity ad zone. In a possible embodiment, the higher-bid advertisement can be shown if the participant client device 102 is in juxtaposition of proximity zones 1300, or more specifically when participant client device 102 is in proximity with, but not within, a given proximity ad zone itself—but close enough for two competing ad zones 2200 to overlap with a proximity reach 152 associated with the participant client device 102. Participant client device 102 can be outside two competing ad zones 2200 but close enough to have juxtaposition of proximity zones 1300 overlap with a proximity zone formed by proximity reach 152 associated with the participant client device 102. In a possible embodiment, an optimal advertisement can be presented which is not based solely on bid amount, but on a combination of factors, by way of non-limiting illustration: location, bid amount, time, keyword, direction, proximity. Advertisement 2202 or 2203 can be in game 101, but need not be in game 101. Advertisement 2202 or 2203 can be an asset 182, for example, a coupon available for a limited time at a predetermined location 105 or a limited edition at a predetermined location 105. There can be any number of competing advertisements. The reference to “first” and “second” need not be construed as a strict reference to time sequence, bid amount, or priority. Second advertisement 2203 can be referenced, created, delivered, bid, terminated, displayed or not displayed at any time. In an embodiment, if participant client device 102 enters into, overlaps accuracy assignment zone 1200 with, or leaves proximity ad zone 2200 or 2201, an alternate advertisement can be displayed on the participant client device 102. An alternate advertisement can be a digital artifact 100. “Entering” or “enter” when used in relation to proximity ad zone 2200 or 2201 can be a progression from being outside proximity ad zone 2200 or 2201, being overlapping with proximity ad zone 2200 or 2201, or actually having a location 104 or 105 within proximity ad zone 2200 or 2201. “Leaving” or “leave” when used in relation to proximity ad zone 2200 or 2201 can occur where participant client device 102, at a given time, is at location 104 or 105 inside proximity ad zone 2200 or 2201; then, at a later time, participant client device 102 is at location 104 or 105 outside proximity ad zone 2200 and 2201, for example, having gap 1500 (FIGS. 11, 15, 15B) upon leaving. In an embodiment, “leaving” can comprise progressive change in location 104 or 105 within proximity ad zone 2200 (or 2201) but toward a periphery of proximity ad zone 2200 or 2201. “Leaving” can be a change in location 104 or 105 toward bounding area 2302 (or 2303) of proximity ad zone 2200 (or 2201) respectively. The alternate advertisement can be by way of non-limiting illustration: a message, for example, “Thank you for visiting XYZ”, an incentive coupon, a marketing communication, first advertisement 2202 or second advertisement 2203, or any number of subsequent advertisements. In an embodiment, second advertisement 2203 can be shown after first advertisement 2202 and upon participant client device 102 leaving proximity ad zone 2200.

First bid amount 2204 can be a designated monetary or non-monetary value which represents the extent of an advertiser's bid, which can then be used for competitive bidding. First bid amount 2204 can be associated with first advertisement 2202. First bid amount 2204 can be compared to second bid amount 2205. First bid amount 2204 can have localization information associated therewith. Non-limiting examples of localization information can include: currency, locale, language, or custom geographic or business locale information associated therewith. Competing advertisements need not be for products or services which directly compete. For example, competing bids can be between or among different products in different markets. By way of non-limiting illustration, an ad for coffee can compete with an ad for auto services—each ad can target a different market, yet each ad can compete to display its advertisement per its respective bid. Further, by way of non-limiting illustration, each competing ad can have a proximity reach 152 or 153, an accuracy assignment zone 1200 associated therewith, or bounding area 2302 or 2303.

Competing advertisement intersection zone 2206 can comprise an intersection of two proximity ad zones 2200 and one accuracy assignment zone 1200. Accuracy assignment zone 1200 can be associated with participant client device 102 at non-predetermined location 104. A benefit of competing advertisement intersection zone 2206 can be to show an advertisement without requiring participant client device 102 to be within a given proximity ad zone 2200 (FIG. 22). “Intersecting” when used in reference to advertising zones can be done with at least partial overlap of an at least one location, or at least one proximity ad zone 2200 with accuracy assignment zone 1200 of participant client device 102.“Competing” with respect to “competing advertisement intersection zone 2206” can refer to bidding competition to display an advertisement when participant client device 102 is proximate to or within competing advertisement intersection zone 2206.

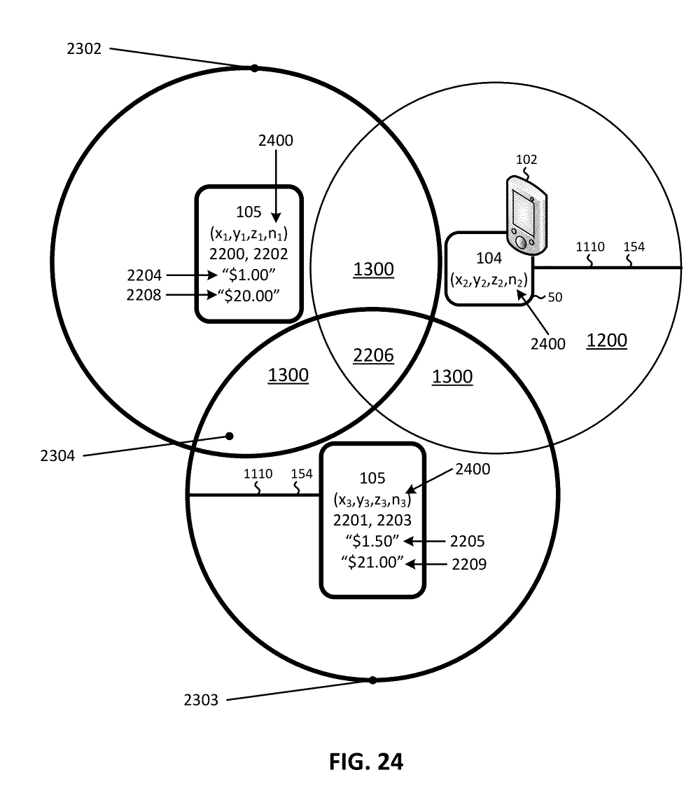

First bid maximum 2208 can be a numeric value, preferably a currency value in the same currency as first bid amount 2204. First bid maximum 2208 can be a ceiling which limits the bid amount for a given advertisement, such as first advertisement 2202. Similarly, second bid maximum 2209 can be associated with second advertisement 2203. Bid maximums can be to facilitate a given advertiser's spending limits on a given advertisement 2202 or 2203, or such limits as associated with a given proximity ad zone 2200 or 2201, for example. A non-limiting example incorporating bid maximum 2208 can include a first bid amount 2204 of $1.00, with up to a first bid maximum 2208 of $20.00. Second advertisement 2203 can comprise second bid amount 2205 at $1.00, with a second bid maximum 2209 of $20.00. If an advertisement has a higher bid but the maximum has been reached, than then the lesser bid advertisement would be shown until its maximum has been reached. In the non-limiting illustration above, first advertisement 2202 has a higher bid maximum than second advertisement 2203; therefore, first advertisement 2202 can be displayed on participant client device 102. There can be bid maximums associated with each proximity ad zone, with each bid, or with each dimension 2400 (FIG. 24). In an embodiment, there can be maximums and minimums to define a bid range associated with a given advertisement 2202 or 2203, or with proximity ad zone 2200 or 2201. In an embodiment, dimension 2400 can have bid maximum 2208 or 2209 associated therewith. In addition to setting a bid, the amount that the advertiser is willing to pay for displaying their advertisement, they can also set a total spend amount 2210.

Total spend amount 2210 can be the maximum amount that they wish to spend when displaying an advertisement. By way of non-limiting illustration, an advertiser can set a bid amount of $0.50 and a total spend amount 2210 of $20.00. Further, each time the corresponding advertisement is displayed, the advertiser's account would be billed for the bid amount, here $0.50. However, the advertiser's account would not be billed more than their total spend amount 2210, here $20.00, and their advertisement will not be displayed more than 40 times in this example (total spend amount of $20.00 limits the number of bids of $0.50 to 40 ad displays of their ad).

FIG. 23 illustrates a schematic diagram of an embodiment of the present invention. Absence of accuracy assignment 2300 is shown in FIG. 23 (in contrast to FIGS. 22 and 22B), with object 50, participant client device 102, non-predetermined location 104, two predetermined locations 105, first proximity reach 152 associated with first advertisement 2202, second proximity reach 153 associated with second advertisement 2203, first proximity ad zone 2200, second proximity ad zone 2201, first bid amount 2204, second bid amount 2205, juxtaposition of proximity zones 1300, first bounding area 2302, second bounding area 2303, and competing bid zone 2304. Participant client device 102 is also shown outside proximity ad zones 2200 and 2201, and outside competing bid zone 2304.

Absence of accuracy assignment 2300 can be associated with non-predetermined location 104 or predetermined location 105. Participant client device 102 can be outside proximity ad zone 2200 or 2201. A benefit of absence of accuracy assignment 2300 can be to show a contrast to embodiments of the present invention where participant client device 102 is outside a competing ad zone, but as seen in FIGS. 22 and 22B, an ad can be displayed even though participant client device 102 is outside a given proximity ad zone 2200 or 2201.

Bounding areas 2302 or 2303 can be formed without accuracy assignment 1100. By way of non-limiting illustration, bounding area 2302 can define the shape of proximity ad zone 2200. In embodiments where proximity ad zone 2200 comprises two or more overlapping bounding areas, first bounding area 2302 can define a shape including at least one or more predefined locations 105 and second bounding area 2303 can define a second shape including a second “at least one or more” predefined locations 105. First advertisement 2202 can have a first bounding area 2302; second advertisement 2203 can have a second bounding area 2303. Bounding area 2302 can be two-dimensional, three-dimensional, or have dimension 2400.

Competing bid zone 2304 can be defined by an intersection of two distinct sets of locations, whether formed by radius 154 (FIG. 22), proximity ad zone 2200, or bounding area 2302 or 2303. Competing bid zone 2304 need not intersect with accuracy assignment 1100, unlike competing advertisement intersection zone 2206. Competing bid zones can be deemed “competing” whether or not two or more proximity ad zones 2200, 2201, overlap at a given time; by way of non-limiting illustration, location 104 or 105 of participant client device 102 and competing bid zone 2304 need not overlap. Rather, accuracy assignment zone 1200 of participant client device 102 can overlap in part with competing bid zone 2304. In a possible embodiment, competing bid zone 2304 can be formed in part by proximity ad zone 2200 and a second proximity ad zone 2201 which can correspond to accuracy assignment zone 1200. In a possible embodiment, competing bid zone 2304 can be formed in part by proximity ad zone 2200 and a second proximity ad zone 2200 which can be larger than, for example, accuracy assignment zone 1200 as shown in FIG. 22-22B.

FIG. 24 illustrates a schematic diagram of a possible embodiment of the present invention. Dimension 2400 is shown in FIG. 24, with object 50, participant client device 102 at non-predetermined location 104, accuracy assignment 1110, accuracy assignment zone 1200, proximity ad zone 2200, first advertisement 2202 at predetermined location 105, and second advertisement 2203 at another predetermined location 105, competing advertisement intersection zone 2206, first bounding area 2302, second bounding area 2303, competing bid zone 2304, competing advertisement intersection zone 2206 shown with participant client device 102, first bid maximum 2208, and second bid maximum 2209.

Dimension 2400 can be a further association other than location. In an embodiment, dimension 2400 can be associated with advertisement 2202 or 2203, or with ad location 2508. By way of non-limiting illustration, dimension 2400 can be time, time range, date range, bid amount, content, competitor, commercial information, event, address, personal information, business information, social network information, category, keyword, set of locations 174, or the outcome of any business rule or logic, any other information, or any combination thereof. In a possible embodiment, dimension 2400 can be time. In a possible embodiment, location 104 or 105 can be present via coordinates x, y, and z with first bid amount 2204, and a range of time as dimension 2400. One of ordinary skill in the pertinent art would understand how to incorporate dimension 2400 into the present invention based on the teachings of this specification.

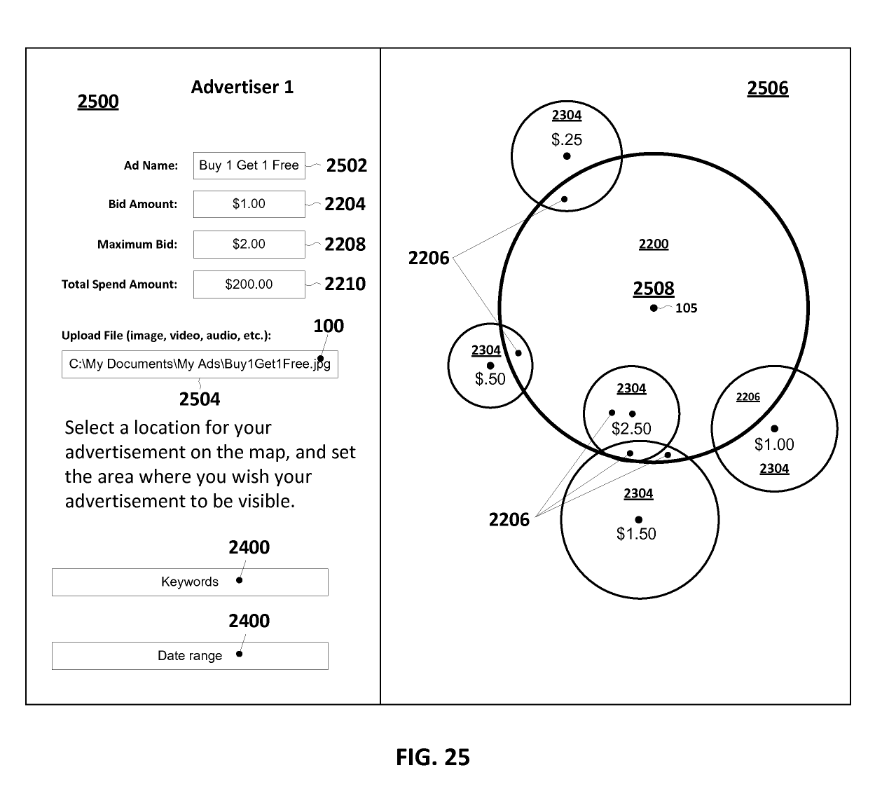

FIG. 25 illustrates a possible self-service user interface of the present invention. Self-service interface 2500 is shown in FIG. 25, with ad name 2502, bid amount 2204, maximum bid amount 2208, total spend amount 2210, advertising asset 2504, map 2506, proximity ad zone 2200 specified at ad location 2508, competing advertisement intersection zone 2206, and competing bid zones 2304. Digital asset 100 can be uploaded via self-service interface 2500 and associated with a new ad location 2508 and with dimension 2400.

Self-service interface 2500 can provide a self-service interface to create an advertisement. Self-service interface 2500 can comprise a control panel and a map 2510. Self-service interface 2500 can provide a prompt to upload an asset 2504. Ad name 2502, bid amount 2204, maximum bid amount 2208, and total spend amount 2210 can be specified in self-service interface 2500. A benefit of self-service interface 2500 can be to allow an advertiser can to create their own ad and see how their ad's bid amounts compare to other ads that intersect, or that are nearby their own ad.

Ad name 2502 can be associated with an advertisement as specified in self-service interface 2500.

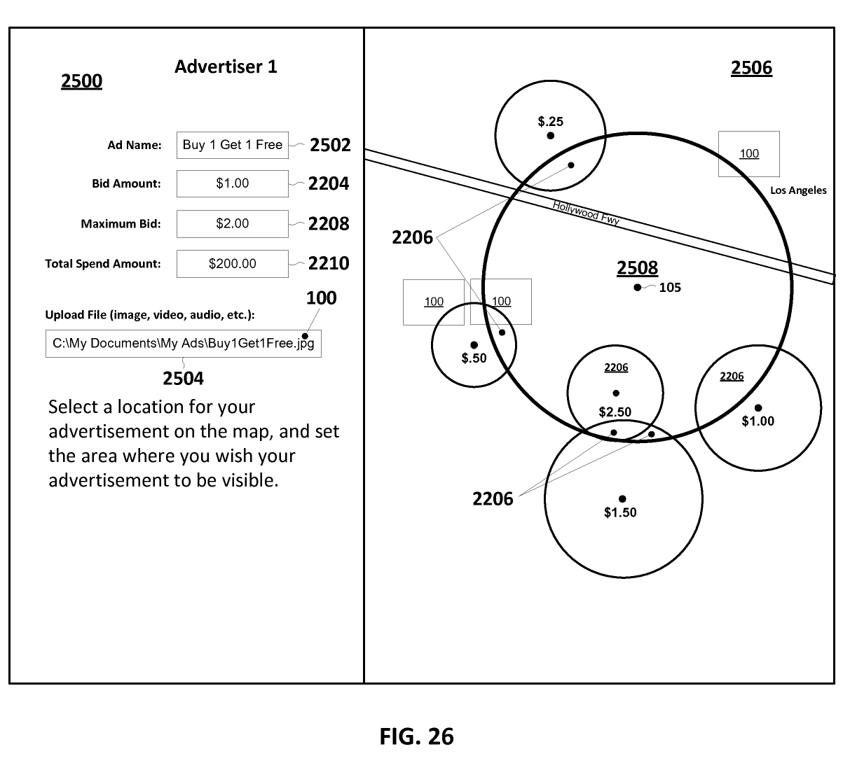

Advertising asset 2504 can be any digital asset 100, whether image, audio, mp3, or any other digital asset 100. Advertising asset 2504 can also be specified as a path, URL, or pointer to the location of the desired digital asset to be uploaded. Advertising asset 2504 can corresponds to an advertisement to be shown on participant client device 102 (FIGS. 22, 22B, 23, and 24). FIGS. 25 and 26 show a non-limiting example of a jpg file as advertising asset 2504.

Map 2506 can have line drawings, the surface of the earth, roads, buildings, landmarks, natural environment, or any combination thereof. Map 2510 as a portion of self-service interface 2500 can be interactive. By clicking at a point on map 2510, a location can be selected and a point can then be shown at the selected point, corresponding to a predetermined location 105 associated with first advertisement 2202. Competing advertisements can be shown in self-service interface 2500, or more specifically, in map 2510. Further, overlapping zones or competing bid zone 2304 can be shown in self-service interface 2500. Competing bid amounts can also be shown in self-service interface 2500, for example, near or within the bounding area for each competing advertisement. An advertiser can set proximity ad zone 2200 at ad location 2508 within map 2506. Setting proximity ad zone 2200 can be done by clicking on map 2506. In an embodiment, the size or boundary of the given proximity ad zone 2200 can be established by clicking, tapping, or releasing a click at a point other than the specific origin point of ad location 2508.

Ad location 2508 can be specified in self-service interface 2500. Ad location 2508 can be specified on map 2506 by any interaction, by way of non-limiting illustration: tap, touch, click, cursor, light receptor, or any other targeting device. Ad location 2508 can have a boundary, location. Ad location 2508 can be an area where an advertiser desires to have their advertisement to be visible.

FIG. 26 illustrates a possible self-service user interface of the present invention with geographic indicia. Map 2506 is shown in FIG. 26 with geographic indicia which can be shown in conjunction with ad location 2508 and other competing ad locations and respective bids and zones. In a possible embodiment, digital asset 100 can be a geographic indicia on map 2506.

What is claimed is:

1. A system, comprising: a first location within a bounding area; a second location within said bounding area; a first bid associated with the first location; and a second bid associated with the second location.

2. the system of claim 1, further comprising: a first digital artifact associated with the first location.

3. the system of claim 2, where the first digital artifact is a first advertisement.

4. the system of claim 3, further comprising: a first proximity ad zone associated with the first location and the first advertisement.

5. the system of claim 4, further comprising: a second proximity ad zone associated with the second location.

6. the system of claim 5, further comprising: an accuracy assignment associated with a participant client device at a non-predetermined location.

7. the system of claim 6, further comprising: an accuracy assignment zone formed around the participant client device,

8. the system of claim 7, where the accuracy assignment zone is based on the accuracy assignment.

9. the system of claim 8, further comprising: a juxtaposition of proximity zones comprising the first proximity ad zone and second proximity ad zone.

10. the system of claim 9, further comprising: an overlapping zone, comprising: the juxtaposition of proximity zones and an at least one non-predetermined location determined by the accuracy assignment zone being within the juxtaposition of proximity zones.

11. the system of claim 10, further comprising:
a multiple overlapping zone, comprising:
a first accuracy assignment zone associated with a first advertisement;
a second accuracy assignment zone associated with a second advertisement; and
a third accuracy assignment zone associated with a participant client device.

12. the system of claim 10, further comprising:
a multiple overlapping zone, comprising:
a first proximity ad zone associated with a first advertisement at a first predetermined location;
a second proximity ad zone associated with a second advertisement at a second predetermined location; and
an at least one non-predetermined location determined by the accuracy assignment zone at a juxtaposition of overlapping zones, where the juxtaposition of overlapping zones is formed by a partial overlap of the first proximity ad zone and the second proximity ad zone.

13. A method, comprising:
receiving a first proximity ad zone associated with a first bid amount;
receiving a second proximity ad zone associated with a second bid amount;
intersecting the first proximity ad zone and the second proximity ad zone.

14. the method of claim 13, further comprising: intersecting the first proximity ad zone, the second proximity ad zone, and an at least one location in an accuracy assignment zone.

15. the method of claim 14, further comprising: assigning an accuracy assignment to a participant client device.

16. the method of claim 15, further comprising: comparing the first bid amount to the second bid amount, where the first bid amount is higher than the second bid amount.

17. the method of claim 16, further comprising: displaying a first advertisement associated with the first bid amount at an earlier time than a second advertisement associated with the second bid amount on the participant client device.

18. A method, comprising:
assigning an accuracy assignment to a participant client device;
assigning a first proximity ad zone around a first advertisement;
associating a first bid with the first advertisement;
assigning a second proximity ad zone around a second advertisement;
associating a second bid with the second advertisement; and
intersecting the first proximity ad zone with the second proximity ad zone.

19. the method of claim 18, further comprising: forming an accuracy assignment zone around the participant client device based on the accuracy assignment.

20. the method of claim 19, further comprising: receiving a participant client device in the first proximity ad zone and in the second proximity ad zone, where the first bid is lower than the second bid, and the second advertisement is displayed on participant client device.

21. the method of claim 20, wherein if the participant client device leaves the first proximity ad zone, an alternate advertisement is displayed on the participant client device.

22. the method of claim 18, wherein if the participant client device leaves the first proximity ad zone and enters the second proximity ad zone, the second advertisement is displayed on the participant client device.

23. the method of claim 18, further comprising: setting a first bid maximum, where the first bid amount is not greater than the first bid maximum.

24. the method of claim 18, further comprising: forming a competing advertisement intersection zone by intersecting the first proximity ad zone with the second proximity ad zone.

25. the method of claim 18, further comprising: specifying a location, setting a proximity ad zone, a first bid amount, a first bid amount associated with the first bid amount, a total spend amount, and a digital artifact associated with the location.

26. the method of claim 18, further comprising: displaying the first advertisement in succession on a plurality of participant client devices, wherein the first bid amount is less than the total spend amount and the first advertisement is displayed again until the total spend amount is exhausted by the first bid amount.

27. A self-service interface system, comprising:
a map;
an ad location, the ad location capable of being specified on the map;
a bid amount associated with the ad location;
a competing bid zone displayed on the map; and
an at least one dimension associated with the ad location, where the dimension is a time range, a date range, a keyword, a competitor, an event, an address, a contact information, a business information, a social network information, a category, a set of locations, a business rule, an outcome of the business rule, or a combination thereof.
